(19) United States
(12) Patent Application Publication
(10) Pub. No.: US 2015/0090621 A1
(43) Pub. Date: Apr. 2, 2015

(54) PRESSURE SENSITIVE ADHESIVE TAPE

(71) Applicant: H.B FULLER COMPANY, ST. PAUL, MN (US)

(72) Inventors: Dennis A. Bradshaw, Damascus, OR (US); Justine Hanlon, Vancouver, WA (US); Kelby V. Ridenour, Portland, OR (US); Bruce J. Shreeve, Portland, OR (US); Jorge A. Nash, Vancouver, WA (US)

(73) Assignee: H.B FULLER COMPANY, ST. PAUL, MN (US)

(21) Appl. No.: 14/041,845

(22) Filed: Sep. 30, 2013

(51) Int. Cl. C09J 7/04; B65D 85/672; B32B 37/12; C09J 7/02

(52) U.S. Cl. CPC C09J 7/045; C09J 7/0207; B65D 85/672; B32B 37/1207; B32B 2037/1215; B32B 2317/127; B32B 2331/04; B32B 2391/00; B32B 2305/30; B32B 2405/00
USPC 206/411; 428/354; 428/167; 156/327

(57) ABSTRACT

A tape comprising:
a first hot melt adhesive composition or plastic composition that provides weft strength to the tape;
a second hot melt adhesive composition that includes a release agent;
an encapsulated fibrous material layer, wherein the fibrous material is encapsulated by (i) the first hot melt adhesive composition or (ii) the second hot melt adhesive composition; and
a pressure sensitive adhesive layer that defines an outer pressure sensitive adhesive surface of the tape;
wherein the first hot melt adhesive composition or plastic composition is located between the second hot melt adhesive composition and the pressure sensitive adhesive layer.

### BACKGROUND

Many consumer items today are packaged by manufacturers for purposes of transportation and shipment to retailers who thereafter remove the items from the container and place them on display in the retail outlet on counters or shelves for the convenience of the consumer. For the most part, such items are packaged in materials such as kraft paper or corrugated board depending on the strength required by the container. In many cases, and particularly with kraft paper packaging material, no opening feature is provided for the container so that, in order to remove the contents thereof, it is necessary to dismantle the container, which may result in its destruction. In some situations, such as containers formed with corrugated board packaging material, an opening feature in the form of score lines which define the desired opening are provided. However, such an opening feature is oftentimes inadequate since the tear resistance of such materials is high resulting in uneven tearing of the packaging material and destruction of the container itself. It is also possible to utilize a sharp object, such as a knife, for the purpose of cutting the packaging material along desired lines. This means, however, is dangerous and can result in injury or damage to the contents of the container and consequent wastage.

As indicated above, containers formed of kraft paper, paperboard or corrugated board containing consumer items are opened and the items removed and positioned on shelves or counters at the retail outlet. In certain embodiments the containers are themselves display-ready after they are opened. Opening of the container and the removal (from non display-ready containers) and display of the consumer items is a labor intensive operation which requires a person to physically perform the necessary operations. A great benefit could, therefore, be derived if the container itself could be utilized at the retail outlet as the display device for the consumer units thereby eliminating much of the labor presently necessary for removing the units from the container for display. However, this is not possible where the container itself is destroyed during the opening process or else, in those situations where an opening feature was provided, this proved to be inadequate.

Pressure sensitive adhesive (PSA) tapes made with thin plastic film substrates are currently available for tear opening of containers, but such tapes do not demonstrate sufficient tensile strength to pull cleanly through paper board substrates, particularly corrugated board substrates. In addition, the PSA plastic film tapes suffer from poor nick resistance and inadequate bond strength to paper board substrates. Further, it is not possible to cut plastic film tapes in line to form a tear tab.

### SUMMARY

Disclosed herein is a tape comprising:

a first hot melt adhesive composition or plastic composition that provides weft strength to the tape;

a second hot melt adhesive composition that includes a release agent;

an encapsulated fibrous material layer, wherein the fibrous material is encapsulated by (i) the first hot melt adhesive composition or (ii) the second hot melt adhesive composition; and

a pressure sensitive adhesive layer that defines an outer pressure sensitive adhesive surface of the tape;

wherein the first hot melt adhesive composition or plastic composition is located between the second hot melt adhesive composition and the pressure sensitive adhesive layer.

Also disclosed herein is a tape consisting of:

an encapsulated fibrous material, wherein the fibrous material is encapsulated by at least 51 g/m² of a hot melt adhesive composition that includes a release agent; and

a pressure sensitive adhesive layer that contacts the encapsulated fibrous material and that defines an outer pressure sensitive adhesive surface of the tape.

Further disclosed herein is a tear opening system for a paper board construct, comprising:

(a) a paper board substrate defining a first surface and a second surface;

(b) at least one tear tape disposed on at least one of the first surface or the second surface of the paper board substrate, wherein the tear tape includes:
a first hot melt adhesive composition or plastic composition that provides weft strength to the tape;
a second hot melt adhesive composition that includes a release agent;
an encapsulated fibrous material layer, wherein the fibrous material is encapsulated by (i) the first hot melt adhesive composition or (ii) the second hot melt adhesive composition; and
a pressure sensitive adhesive layer that defines an outer pressure sensitive adhesive surface of the tape;
wherein the first hot melt adhesive composition or plastic composition is located between the second hot melt adhesive composition and the pressure sensitive adhesive layer; and

(c) a tear-initiating element associated with the tear tape and the paper board substrate.

Additionally disclosed herein is a tear opening system for a paper board construct, comprising:

(a) a paper board substrate defining a first surface and a second surface;

(b) at least one tear tape disposed on at least one of the first surface or the second surface of the paper board substrate, wherein the tear tape consists of:
an encapsulated fibrous material, wherein the fibrous material is encapsulated by at least 51 g/m² of a hot melt adhesive composition that includes a release agent; and
a pressure sensitive adhesive layer that contacts the encapsulated fibrous material and that defines an outer pressure sensitive adhesive surface of the tape; and

(c) a tear-initiating element associated with the tear tape and the paper board substrate.

Further disclosed herein is a container comprising:

at least one side wall panel comprising a corrugated board substrate, wherein the side wall panel defines an exterior surface and an interior surface; and

a tear opening system, wherein the tear opening system comprises:

(a) a paper board substrate defining a first surface and a second surface;

(b) at least one tear tape disposed on at least one of the first surface or the second surface of the paper board substrate, wherein the tear tape includes:
a first hot melt adhesive composition or plastic composition that provides weft strength to the tape;
a second hot melt adhesive composition that includes a release agent;
an encapsulated fibrous material layer, wherein the fibrous material is encapsulated by (i) the first hot melt adhesive composition or (ii) the second hot melt adhesive composition; and
a pressure sensitive adhesive layer that defines an outer pressure sensitive adhesive surface of the tape;
wherein the first hot melt adhesive composition or plastic composition is located between the second hot melt adhesive composition and the pressure sensitive adhesive layer, and

(c) a tear-initiating element associated with the tear tape and the paper board substrate.

Also disclosed herein is a container comprising:

at least one side wall panel comprising a corrugated board substrate, wherein the side wall panel defines an exterior surface and an interior surface; and

a tear opening system, wherein the tear opening system comprises:

(a) a paper board substrate defining a first surface and a second surface;

(b) at least one tear tape disposed on at least one of the first surface or the second surface of the paper board substrate, wherein the tear tape consists of:
an encapsulated fibrous material, wherein the fibrous material is encapsulated by at least 51 g/m² of a hot melt adhesive composition that includes a release agent; and
a pressure sensitive adhesive layer that contacts the encapsulated fibrous material and that defines an outer pressure sensitive adhesive surface of the tape; and

(c) a tear-initiating element associated with the tear tape and the paper board substrate.

Additionally disclosed herein is a method for making a tear opening system for a paper board construct having a first surface and an opposing second surface, comprising:

applying at least one tear tape to at least the first surface of the paper board construct or the second surface of the paper board construct at a dry end section of a paper board construct manufacturing process, wherein the tear tape includes:
a first hot melt adhesive composition or plastic composition that provides weft strength to the tape;
a second hot melt adhesive composition that includes a release agent;
an encapsulated fibrous material layer, wherein the fibrous material is encapsulated by (i) the first hot melt adhesive composition or (ii) the second hot melt adhesive composition; and
a pressure sensitive adhesive layer that defines an outer pressure sensitive adhesive surface of the tape;
wherein the first hot melt adhesive composition or plastic composition is located between the second hot melt adhesive composition and the pressure sensitive adhesive layer, and

wherein the tear tape is applied such that the pressure sensitive adhesive surface of the tear tape adheres to the first surface or the second surface of the paper board substrate.

Also disclosed herein is a method for making a tear opening system for a paper board construct having a first surface and an opposing second surface, comprising:

applying at least one tear tape to at least the first surface of the paper board construct or the second surface of the paper board construct at a dry end section of a paper board construct manufacturing process, wherein the tear tape consists of:
an encapsulated fibrous material, wherein the fibrous material is encapsulated by at least 51 g/m² of a hot melt adhesive composition that includes a release agent; and
a pressure sensitive adhesive layer that contacts the encapsulated fibrous material and that defines an outer pressure sensitive adhesive surface of the tape, and

wherein the tear tape is applied such that the pressure sensitive adhesive surface of the tear tape adheres to the first surface or the second surface of the paper board substrate.

The foregoing will become more apparent from the following detailed description, which proceeds with reference to the accompanying figures.

### BRIEF DESCRIPTION OF THE DRAWINGS

FIG. 1A is a perspective view of a cross-section of a first embodiment of a PSA tape disclosed herein. The view of FIG. 1A is from line A-A as shown in FIGS. 1B and 1B.

FIG. 1B is a perspective view of one embodiment of a tape roll as disclosed herein.

FIG. 1C is a perspective view of another embodiment of a tape roll as disclosed herein.

FIG. 2 is a perspective view of a cross-section of a second embodiment of a PSA tape disclosed herein. The view of FIG. 2 is from line A-A as shown in FIGS. 1B and 1B.

FIG. 3 is a perspective view of a cross-section of a third embodiment of a PSA tape disclosed herein. The view of FIG. 3 is from line A-A as shown in FIGS. 1B and 1B.

FIG. 4 is a perspective view of a cross-section of a fourth embodiment of a PSA tape disclosed herein. The view of FIG. 2 is from line A-A as shown in FIGS. 1B and 1B.

FIG. 5A is a perspective view of one embodiment of a paper board substrate that is partially torn via a tear tape opening system as disclosed herein.

FIG. 5B is an exploded view of a portion of the paper board substrate shown in FIG. 5A.

FIG. 6A is a perspective view of another embodiment of a paper board substrate that is partially torn via a tear tape opening system as disclosed herein.

FIG. 6B is an exploded view of a portion of the paper board substrate shown in FIG. 6A.

FIG. 7 is a perspective view of a cross section of a paper board substrate and a PSA tape as disclosed herein.

FIG. 8 is a side view of a process for making the paper board substrate/PSA tape embodiment of FIG. 7.

FIG. 9 is a perspective view of a cross section of one embodiment of a paper board substrate and a two tape opening system as disclosed herein.

FIG. 10 is a side view of a process for making the paper board substrate/PSA tape embodiment of FIG. 9.

FIG. 11 is a perspective view of a cross section of another embodiment of a paper board substrate and a two tape opening system as disclosed herein.

FIG. 12 is a side view of a process for making the paper board substrate/PSA tape embodiment of FIG. 11.

FIG. 13 is a perspective view of a container that includes a PSA tape as disclosed herein.

### DETAILED DESCRIPTION

### PSA Tape

In certain embodiments, the fibrous material is encapsulated with a thermoplastic composition (which in certain embodiments may be a hot melt adhesive) that provides a unified substrate for bonding other layers to, such as a second hot melt composition layer. The tape also includes a PSA surface that creates a bond with a paper board substrate. In addition, the tape includes a release agent that prevents the PSA surface of the tape from adhering to the opposing surface of the tape when the tape is wound upon itself. Various layers of the tapes impart sufficient weft strength to the tape. The tape may have a high weft strength, but it has a propensity to tear only in the tape lengthwise direction.

As described herein, a hot melt composition may be utilized to encapsulate the fibrous material. In one embodiment, the encapsulating hot melt composition (which is referred to herein as a “first hot melt composition”) provides weft strength to the tape, but does not include a release agent. In another embodiment, the encapsulating hot melt composition (which is referred to herein as a “second hot melt composition” or a “release hot melt composition”) includes a release agent. The hot melt compositions should not be heat-activated under dry end corrugator conditions (described below in more detail). Re-activation of the hot melt compositions during the paper board/container manufacturing process would be undesirable since a purpose of the hot melt compositions is to maintain a unified fibrous substrate.

In certain embodiments, the tape consists of three layers: a substrate consisting of a fibrous material that is at least partially encapsulated with an encapsulating composition that includes a release agent; a hot melt composition layer contacting the fibrous substrate; and a pressure sensitive adhesive layer contacting the hot melt composition layer. In other embodiments, the tape consists of two layers: a substrate consisting of a fibrous material that is at least partially encapsulated with an encapsulating composition that includes a release agent; and a pressure sensitive adhesive layer contacting the fibrous substrate. In further embodiments, the tape consists of three layers: a substrate consisting of a fibrous material that is at least partially encapsulated with an encapsulating composition that includes a release agent; a plastic composition layer contacting the fibrous substrate; and a pressure sensitive adhesive layer contacting the plastic composition layer. In additional embodiments, the tape consists of three layers: a substrate consisting of a fibrous material that is at least partially encapsulated with a pressure sensitive adhesive; a first hot melt composition layer contacting the fibrous substrate; and a release agent-containing second hot melt composition layer contacting the first hot melt composition layer.

### First Hot Melt Composition

The first hot melt composition useful in the presently disclosed tape typically are thermoplastics based on polymer compositions that liquefy between temperatures of 80° C. to 220° C. and solidify again when cooled. In certain embodiments, the hot melt composition has a melt point of at least 90° C. to avoid re-activation during the paper board/container manufacturing process. Hot melts are desirable for their quick setting and/or the absence of aqueous or solvent media that provide fluidity to other types of adhesives. They include a dry polymer (less than 5% liquid) and are applied in a molten state without using water or solvents.

The first hot melt compositions may include 20-50 wt. % ethylene vinyl acetate (EVA) polymer (based on the total dry weight percentage of the adhesive composition), and a tackifying component selected from a tackifying hydrocarbon resin/rosin ester, a tackifying hydrocarbon resin/rosin ester, or a mixture of a tackifying hydrocarbon resin/rosin ester and a tackifying hydrocarbon resin/rosin ester. In certain embodiments, the adhesive compositions include 20-60 wt. % tackifying hydrocarbon resin/rosin ester, and 20-40 wt. % tackifying terpene phenolic resin or an equivalent, based on the total dry weight percentage of the adhesive composition. The compositions may also optionally include 5-40 wt. % of a wax compatible with the ethylene vinyl acetate and 0.1-2 wt. % of a stabilizing additive. The first hot melt composition may also include a film-forming polymer that contributes to providing improved weft strength to the tape. Illustrative film-forming polymers include metallocene catalyst-based homopolymers such as propylene homopolymers, particularly ultrahigh molecular weight polypropylene available from LyondellBasell or Ashland under the tradename METOCENE; polyolefin plastomer (e.g., AFFINITY 1900 available from Dow Chemical); ethylene methyl acrylate copolymer (e.g. OPTEMA available Exxon Mobil), polyester or polyamide. The film-forming polymer may be present in an amount of 10 to 80 wt. %, more particularly 20 to 50 wt. %., based on the total dry weight percentage of the adhesive composition.

A free-standing film made from the first hot melt composition (not a film that may exist in the finished tape) may have a percent elongation of 100 to 300%. The free-standing film may have a tensile strength of 500-1600 psi.

The terms “ethylene-vinyl acetate” or “EVA” refer to the use of that copolymer in hot-melt applications. For example, representative EVAs include ethylene-vinyl ester copolymers wherein the vinyl ester comonomer is typically a C₂-C₆ ester, for example, methylacrylate, ethylacrylate, or butylacrylate. Typically the ester content will be about 18 to 40 wt. %, preferably about 25-35 wt. %. The melt index (“MFI”) (gram flow/10 min., ASTM D 1238-82 Cond. E) will typically range between 2 and 2500, more typically 6 to 500, preferably 6-400. The EVA can be either of the high or low alkyl-branch containing copolymers conventionally known in the art. The commercially available EVA ESCORENE® UL 7760 (MFI=5.7, vinylacetate 26.7 wt. %) from Exxon Chemical Company, EVA ATEVA 2810A from AT Plastics, and EVA ELVAX 260 from DuPont is typical. The ethylene-vinyl acetate component makes up a principal part of the adhesive composition. Typically that amount will be greater than about 20 wt. %, based on the total blend weight, preferably greater than about 25 wt. %, and most preferably greater than about 40 wt. %. The amount is typically less than about 50 wt. %, preferably 45 wt. %, or lower. Thus an amount between 30 and 45 wt. % will be particularly useful.

The hydrocarbon tackifying resins and tackifying terpene phenolic resin include any of those that are compatible with the EVA. Rosin esters may also be used. For example the C₅/C₉ resins, any of the C₄, C₅ and/or C, and/or terpene, containing resins that also contain a significant portion of C₈, C₉ and/or C₁₀ monomers, e.g., styrene or alkyl-substituted styrene monomers will be suitable. Such are available commercially as nonhydrogenated or hydrogenated hydrocarbon resins prepared by Friedel-Crafts polymerization and if hydrogenated, by conventional metal-catalyzed hydrogenation. Monomers can be provided as pure monomer streams, or pure monomer in solvent, or steam-distilled petroleum fractions, for example, heart cut distillate. Preferred resins are the aromatic modified aliphatic C₅/C₉, aromatic modified terpene resins or aromatic aliphatic modified terpene resins prepared with or from steam-cracked petroleum fractions and having number-average molecular weights (Mₙ) less than or equal to 900, viscosity-average molecular weights (M_{z}) less than or equal to 3000, a molecular weight distribution (MWD) less than or equal to 2.1, and an aromaticity of 10-40 wt. % aromatic monomers based on total resin number average molecular weight preferably 15-35 wt. %. Resins of similar monomers meeting these physical parameters will be also be particularly suitable. Commercially available resins that are suitable include the SYLVALITE resins of Arizona Chemical Company, particularly the Rosin Ester resins RE 100F resin products as well as the WESTREZ resins of MeadWestVaco, particularly the 5000 resin products. The most suitable resins have a softening point (Ring & Ball) of 50-120° C., preferably 70-105° C., and most preferably 80-105° C. Below about 50° C. softening point the resins can cause undesirable loss of heat resistance for the adhesive compositions of the invention. The hot melt adhesive compositions of the invention preferably will contain from 30-60 wt. % more preferably 35-45 wt. % tackifying resin. In certain embodiments, the hydrocarbon resin is an aliphatic-aromatic resin having from 10 to 40 wt. %, of total resin number-average molecular weight, of aromatic monomer as measured by NMR. In certain embodiments, the first hot melt composition may include 5 to 30 wt % of a gum rosin to assist in substrate penetration.

The compositions may also include antioxidants. The antioxidants, if used, are generally present in amounts of about 0.1 to 1.5 weight percent, preferably 0.25 to 1.0 weight percent. Such antioxidants are commercially available from Ciba-Geigy, Hawthorne, N.Y. and include Irganox® 565, 1010 and 1076 which are hindered phenols. These are primary antioxidants which act as radical scavengers and may be used alone or in combination with other antioxidants such as phosphite antioxidants like Irgafos® 168 available from Ciba-Geigy. Phosphite catalysts are considered secondary catalysts and are not generally used alone. These are primarily used as peroxide decomposers. Other available catalysts are Cyanox® LTDP available from Cytec Industries in Stamford, Conn., and Ethanox® 1330 available from Albemarle Corp. in Baton Rouge, La. Many such antioxidants are available either to be used alone or in combination with other such antioxidants. These compounds are added to the hot melts in small amounts and have no effect on other physical properties. Other compounds that could be added that also do not affect physical properties are pigments which add color, or fluorescing agents, to mention only a couple. Additives like these are known to those skilled in the art. The performance of the antioxidants] may be further enhanced by utilizing, in conjunction therewith, known synergists such as, for example, thiodipropionate esters and phosphites. Distearylthiodipropionate is particularly useful.

Depending on the contemplated end uses of the adhesives, other additives such as plasticizers, pigments, dyestuffs and fillers conventionally added to hot melt adhesives may be included. In addition, small amounts of additional tackifiers and/or waxes such as microcrystalline waxes, hydrogenated castor oil and vinyl acetate modified synthetic waxes may also be incorporated in minor amounts, i.e., up to about 10% by weight, into the formulations of the present invention.

### Second or Release Hot Melt Adhesive Composition

The second or release hot melt adhesive compositions useful in the presently disclosed tape typically are thermoplastics based on polymer compositions that liquefy between temperatures of 80° C. to 220° C. and solidify again when cooled. In certain embodiments, the hot melt adhesive composition has a melt point of at least 90° C. to avoid re-activation during the paper board/container manufacturing process. Hot melt adhesives are desirable for their quick setting and/or the absence of aqueous or solvent media that provide fluidity to other types of adhesives. They include a dry polymer (less than 5% liquid) and are applied in a molten state without using water or solvents. In general, the second or release hot melt adhesive composition disclosed herein may include a base polymer selected from a low molecular weight polyethylene homopolymer (LMPE), ethylene vinyl acetate copolymer (EVA), a polyamide and/or a moisture cross-linkable polyurethanes or combinations thereof.

The EVA copolymer includes copolymers derived from the copolymerization of ethylene and vinyl acetate. The relative amount of the vinyl acetate comonomer incorporated into ethylene/vinyl acetate copolymers can, in principle, vary broadly from a few weight percent up to as high as 45 weight percent of the total copolymer or even higher. The relative amount of the vinyl acetate present can be viewed as establishing how and to what degree the resulting ethylene copolymer is to be viewed as a polar polymeric constituent in the blended composition. The ethylene/vinyl acetate copolymer can have varied amounts of vinyl acetate content, but preferably has a vinyl acetate unit content of from 6 to 40% by weight, especially from 12 to 32% by weight. The ethylene/vinyl acetate copolymer may optionally be modified by methods well known in the art (for example, grafting), including modification with an unsaturated carboxylic acid or its derivatives. Suitable ethylene/vinyl acetate copolymers include those available from E.I. du Pont de Nemours and Company (DuPont), Wilmington, Del. under the ELVAX tradename. Other ethylene/vinyl acetate copolymers are available from Exxon Chemical Co. under the tradename ESCORENE and also from Millennium Petrochemicals, Rolling Meadows, Ill., under the tradename ULTRATHENE and AT copolymers available from AT Polymers & Film Co., Charlotte, N.C. and EVATANE from Atofina Chemicals, Philadelphia, Pa. A mixture of two or more different ethylene/vinyl acetate copolymers can be used in the hot melt adhesive compositions in place of a single copolymer as long as the average values for the comonomer content will be within the range indicated above.

The second or release hot melt adhesive composition may also include a film-forming polymer that contributes to providing improved weft strength to the tape. Illustrative film-forming polymers include metallocene catalyst-based homopolymers such as propylene homopolymers, particularly ultrahigh molecular weight polypropylene available from LyondellBasell or Ashland under the tradename METOCENE; polyolefin plastomer (e.g., AFFINITY 1900 available from Dow Chemical); ethylene methyl acrylate copolymer (e.g. OPTEMA available Exxon Mobil), polyester or polyamide. The film-forming polymer may be present in an amount of 10 to 80 wt %, more particularly 20 to 50 wt %.

Waxes optionally can be used to modify the properties of a hot melt composition. Wax can reduce the overall viscosity of the adhesive, thereby allowing it to liquefy easily. The wax may also control the open time, set speed and thermal stability of the system. The wax, when present, is preferably included in a finite amount of at least about 0.1 weight %, at least about 2 weight %, or at least about 5 weight % of the total weight of the adhesive composition. Also preferably, the wax is present in a finite amount of up to about 10 weight %, 20 weight %, 25 weight %, 30 weight %, 35 weight %, 40 weight %, or 50 weight %, based on the total weight of the adhesive composition.

Suitable waxes include paraffin waxes, microcrystalline waxes, high-density low molecular weight polyethylene waxes, by-product polyethylene waxes, Fischer-Tropsch waxes, oxidized Fischer-Tropsch waxes and functionalized waxes such as hydroxy stearamide waxes and fatty amide waxes. The term “synthetic high melting point waxes” includes high-density low molecular weight polyethylene waxes, by-product polyethylene waxes and Fischer-Tropsch waxes. Modified waxes, such as vinyl acetate-modified and maleic anhydride-modified waxes may also be used.

Notable paraffin waxes have a ring and ball softening point of about 55° C. to about 85° C. Paraffin waxes include OKERIN 236 TP available from Astor Wax Corporation, Doraville, Ga.; PENRECO 4913 available from Pennzoil Products Co., Houston, Tex.; R-7152 Paraffin Wax available from Moore & Munger, Shelton, Conn.; and Paraffin Wax 1297 available from International Waxes, Ltd in Ontario, Canada. Other notable paraffin waxes have melting points in the range of about 55 to 75° C., such as, for example, PACEMAKER available from Citgo, and R-2540 available from Moore and Munger and low melting synthetic Fischer-Tropsch waxes having a melting point of less than about 80° C. Particularly notable is paraffin wax with a melting point of about 65° C. Other paraffinic waxes include waxes available from CP Hall (Stow, Ohio) under the product designations 1230, 1236, 1240, 1245, 1246, 1255, 1260 and 1262.

Wax may be present in up to 50 weight % of the hot melt composition; for example, from 10 to 50 weight % when a tackifier is not present. When used in combination with at least one tackifier, preferably from about 5 to about 45 weight % wax is present. Preferred waxes have a melting point of from about 60° C. to about 68° C. and have oil content of less than about 0.5, preferably less than about 0.2 weight %.

Optionally, tackifiers may be used in the hot melt adhesive compositions primarily to enhance initial adhesion to differentiated substrates. Tack is useful in a hot melt adhesive composition to allow for proper joining of articles before the heated adhesive hardens. Tackifiers are added to give tack to the adhesive and also to lower viscosity. The tackifier allows the composition to be more adhesive by improving wetting during the application. The presence of tackifiers lowers the resistance to deformation and hence facilitates bond formation on contact.

The tackifier, when present, is preferably included in a finite amount of at least about 0.1 weight %, at least about 2 weight %, or at least about 5 weight % of the total weight of the adhesive composition. Also preferably, the tackifier is present in a finite amount of up to about 10 weight %, 20 weight %, 25 weight %, 30 weight %, 35 weight %, 40 weight %, or 50 weight %, based on the total weight of the adhesive composition.

The tackifier may be any suitable tackifier known generally in the art such as those listed in U.S. Pat. No. 3,484,405. Such tackifiers include a variety of natural and synthetic resins and rosin materials. The resins that can be employed are liquid, semi-solid to solid, complex amorphous materials generally in the form of mixtures of organic compounds having no definite melting point and no tendency to crystallize. Such resins are insoluble in water and can be of vegetable or animal origin, or can be synthetic resins. The resins can provide substantial and improved tackiness to the composition. Suitable tackifiers include but are not necessarily limited to the resins discussed below.

A class of resin components that can be employed as the tackifier composition is the coumarone-indene resins, such as the para-coumarone-indene resins. Generally the coumarone-indene resins that can be employed have a molecular weight that ranges from about 500 to about 5,000. Examples of resins of this type that are available commercially include those materials marketed as PICCO-25 and PICCO-100.

Another class of tackifier resins is terpene resins, including also styrenated terpenes. These terpene resins can have a molecular weight range from about 600 to 6,000. Typical commercially available resins of this type are marketed as PICCOLYTE S-100, as STAYBELITE Ester #10, which is a glycerol ester of hydrogenated rosin, and as WINGTACK 95, which is a polyterpene resin.

A third class of resins that can be employed as the tackifier are the so-called hydrocarbon resins produced by catalytic polymerization of selected fractions obtained in the refining of petroleum, and having a molecular weight range of about 500 to about 5,000. Examples of such resin are those marketed as PICCOPALE-100, and as AMOCO and VELSICOL resins.

The tackifier may also include rosin materials, low molecular weight styrene hard resins such as the material marketed as PICCOLASTIC A-75, disproportionated pentaerythritol esters, and copolymers of aromatic and aliphatic monomer systems of the type marketed as VELSICOL WX-1232.

Rosins useful as tackifiers may be any standard material of commerce known as “rosin”, or a feedstock containing rosin. Rosin is mainly a mixture of C₂₀, tricyclic fused-ring, monocarboxylic acids, typified by pimaric and abietic acids, which are commonly referred to as “resin acids.” Any one or more of the C₂₀ cyclic carboxylic acid-containing isomers present in rosin may be used. Rosin is the residue left after distilling off the volatile oil from the oleoresin obtained from Pinus palustris and other species of Pinus, Pinaceae. It is available as wood rosin (from Southern pine stumps after harvesting the stumps, chipping the stumps into small chips, extracting the chips with hexane or higher-boiling paraffin, and distilling the hexane or paraffin to yield wood rosin) gum rosin (the exudates from incisions in the living tree, P. palustris and P. caribaea) and tall oil rosin. Rosin contains about 90% resin acids and about 10% neutral matter. The acids present in natural rosin may be purified by, for example, by saponification, extraction of the neutral matter and reacidifying. Of the resin acids about 90% are isomeric with abietic acid (C₂₀H₃₀O₂); the other 10% is a mixture of dihydroabietic acid (C₂₀H₃₂O₂) and dehydroabietic acid (C₂₀H₂₈O₂). (See The Merck Index, Tenth Ed. Rahway, N.J., USA, 1983, page 1191, entry 8134). Tall oil, also known as liquid rosin, is a byproduct of the wood pulp industry and is usually recovered from pinewood “black liquor” of the sulfate or Kraft paper process. According to the Kraft process, pinewood is digested with alkali and sulfide, producing tall oil soap and crude sulfate turpentine as by-products. Acidification of this soap followed by fractionation of the crude tall oil yields tall oil rosin and fatty acids. Tall oil typically contains rosin acids (34 to 40%), fatty acids such as oleic and linoleic acids (50-60%) and neutral matter (5 to 10%). (See The Merck Index, Tenth Ed., page 1299, entry 8917). Preferably, the rosin contains at least 90 weight % resin acids, and less than 10 weight % fatty acids. Some rosin dimerization product, which may form during the fractionation process, may also be present in the tall oil rosin. Rosin is available commercially in several grades (for example, under the tradename RESINALL from Resinall Corporation, and other products supplied by Hercules, Aarakawa, etc.). A standard grade of rosin is available commercially from Union Camp Corporation (Wayne, N.J.) under the UNITOL tradename. Commercially available rosins that can be used to practice the invention also include SYLVARES RE 115, available from Arizona Chemical and SYLVARES RE 104, available from Arizona Chemical.

As used herein, the term “rosin” collectively includes natural rosins, liquid rosins, modified rosins and the purified rosin acids, and derivatives of rosin acids, including partially to completely neutralized salts with metal ions, e.g. resinate, etc. The rosin may be gum, wood or tall oil rosin but preferably is tall oil rosin.

The rosin material may be modified rosin such as dimerized rosin, hydrogenated rosin, disproportionated rosin, or esters of rosin. Essentially any reaction conditions recognized in the art for preparing modified rosin resins (including derivatives thereof) may be employed to prepare a modified rosin. Rosins can be modified by, for example, esterification of some or all of the carboxylic moieties or by forming carboxylate salts by saponification. Esters can be prepared by esterifying the rosin with polyhydric alcohols containing from 2 to 6 alcohol groups.

Phenolic-modified rosin esters are typically prepared by the reaction of rosin and a phenolic compound. This phenolic resin is then esterified with a polyhydric alcohol providing phenolic-modified rosin esters. Typically, the combinations of reactants are exposed to an elevated temperature in the range of 100 to 300° C. At these elevated temperatures, the reactants undergo covalent bond-forming reactions with other reactants, so that a resinous material is formed. Reaction products of rosins and their methods of preparation are well known in the art (See for example U.S. Pat. No. 2,007,983).

Aromatic tackifiers include thermoplastic hydrocarbon resins derived from styrene, alpha-methylstyrene, and/or vinyltoluene, and polymers, copolymers and terpolymers thereof, terpenes, terpene phenolics, modified terpenes, and combinations thereof. KRISTALEX 3100 is a low molecular weight thermoplastic hydrocarbon polymer derived largely from alphamethylstryene with a Ring and Ball softening point of 97 to 103° C., commercially available from Eastman Chemical Company (Kingsport, Tenn.).

A more comprehensive listing of tackifiers, which can be employed, is provided in the TAPPI CA Report #55, February 1975, pages 13-20, inclusive, a publication of the Technical Association of the Pulp and Paper Industry, Atlanta, Ga., which lists well over 200 tackifier resins that are commercially available.

Preferred tackifiers will generally have average softening points ranging from about 85° C. to about 130° C., more typically from about 100° C. to about 125° C., will have a weight average molecular weight greater than about 1000, will have an acid number of less than about 20 and will have a viscosity at 125° C. of greater than about 10,000 cp.

One can determine the molecular weight and softening point of a tackifier by dissolving the material in a suitable solvent such as tetrahydrofuran, and analyzing a sample of that solution using gel permeation chromatography. The molecular weight average in grams/mole, Mw, is determined by comparison to the retention time and elution profile of polystyrene standards of known molecular weight (commercially available from many Chromatography supply houses, e.g., Supelco, Inc. or Waters Associates). The softening point may be measured using a Mettler FP90 Central Processor and a Mettler FP83 HT Dropping Point cell with a softening point ring.

Tackifiers may be present in up to 50 weight % of the hot melt composition; for example, from 10 to 50 weight % when wax is not present. When used in combination with wax, about 5 to about 45 weight % of tackifier may be present. Mixtures of two or more of the tackifying resins may be required for some formulations.

The hot melt adhesive composition can optionally include a plasticizer. Possible plasticizers include oil, butadiene-styrene resins having a molecular weight ranging from about 500 to about 5,000. A typical commercial product of this type is marketed as BUTON 100, a liquid butadiene-styrene copolymer resin having a molecular weight of about 2,500; polybutadiene resins having a molecular weight ranging from about 500 to about 5,000. A commercially available product of this type is that marketed as BUTON 150, a liquid polybutadiene resin having a molecular weight of about 2,000 to about 2,500. Similarly, polybutenes obtained from the polymerization of isobutylene may be included.

In the embodiments disclosed herein in which a release agent is included in a hot melt composition, the release agent may be an internal release agent that “blooms” to the surface of the tape ducting manufacture of the tape. In other words, the release agent is a surface-migratory release agent.

The release agent may have a high melting point (e.g., at least about 120° C.) so that the release agent does not melt during the paper board substrate/tape manufacturing process. Illustrative release agents include ethyl acrylate-acrylonitrile copolymer, an acrylic acid-alkyl acrylate copolymer (e.g., acrylic acid-ethyl acrylate copolymer), a polyvinyl chloride resin, a polyvinyl N-octadecyl carbamate, a polyethylene based wax, a polyamide based wax, a polysiloxane, a fluorocarbon polymer, a-polyvinyl ester (e.g., vinyl stearate, vinyl palmitate, etc.), a polyethylene imine, an alkyl substituted amine, a fatty acid material (such as a fatty acid-based wax (e.g., a fatty acid condensate)), a chromium complex (e.g., stearate chromic chloride), and mixtures thereof. Illustrative fatty acid release agents include saturated or unsaturated compounds having 4 to 26 carbon atoms. The fatty acid release agent may be in the form of a fatty acid, a fatty acid ester, fatty acid amides (e.g., oleamide, stearamide, erucamide, behenamide, N-oleylpalmitide, N-stearyl erucamide) or a fatty acid condensate. Examples of such release coating compositions include those commercially available under the trade designations MICROMID 321RC (a polyamide dispersion) from Union Camp Corp., Jacksonville, Fla., FC270 (a fluorochemical) from Minnesota Mining & Manufacturing Co., St. Paul, Minn., NORPEL 7645 (a fatty acid condensate), and NORPEL 32776 (an ethylene bisstearamide) from Northern Products, Inc. Woonsocket, R.I., and ACRAWAX (an ethylene bisstearamide) from Lonza Inc. In certain embodiments, the release agent is present in the hot melt adhesive composition in an amount of 5 to 30, particularly 7 to 20.5, and more particularly 10 to 20 weight percent, based on the total weight of the hot melt adhesive composition. The amount of the release agent, and type of release agent, should be tailored so that the tape can release from the PSA surface as the tape is unwound from the tape roll, while the hot melt adhesive composition retains sufficient bonding strength to maintain the structural unity of the fibrous material.

In certain embodiments the second or release hot melt adhesive composition may include 10 to 60, more particularly 30 to 50, weight percent of EVA as a base polymer; 10 to 40, more particularly, 15 to 35, weight percent at least one tackifier; 5 to 30, more particularly 10 to 25, weight percent, of a wax; and 5 to 30, more particularly 7 to 20.5, weight percent of a release agent, based on the total weight of the hot melt adhesive composition.

### Plastic Composition

Certain tape embodiments also may include a plastic composition that is different than the first hot melt composition or second hot melt composition. In particular, the plastic composition does not include an ethyl vinyl acetate copolymer. The plastic composition includes at least one film-forming polymer and at least one wax. In certain embodiments, the film-froming polymer(s) may be present in an amount of 30-95 wt. %, more particularly 80 to 93 wt. %, and the wax may be present in an amount of 3-20 wt. %, more particularly 5-15 wt. %. The wax contributes to adjusting the viscosity of the plastic composition, and the softening point of the plastic composition. The film-forming polymer(s) contribute to providing the desired weft strength to the tape. In addition, the film-forming polymer(s) also adjust the flexbility or brittleness of the coating formed from the composition, as well as the viscosity of the composition. For example, a greater amount of film-forming polymer(s) will increase the coating brittleness and increase the viscosity.

Illustrative film-forming polymers include metallocene catalyst-based homopolymers such as propylene homopolymers, particularly ultrahigh molecular weight polypropylene available from LyondellBasell or Ashland under the tradename METOCENE; polyolefin plastomer (e.g., AFFINITY 1900 available from Dow Chemical); ethylene methyl acrylate copolymer (e.g. OPTEMA available Exxon Mobil), polyester or polyamide.

Wax can reduce the overall viscosity of the adhesive, thereby allowing it to liquefy easily. The wax may also control the open time, set speed and thermal stability of the system. Suitable waxes include paraffin waxes, microcrystalline waxes, high-density low molecular weight polyethylene waxes, by-product polyethylene waxes, Fischer-Tropsch waxes, oxidized Fischer-Tropsch waxes and functionalized waxes such as hydroxy stearamide waxes and fatty amide waxes. The term “synthetic high melting point waxes” includes high-density low molecular weight polyethylene waxes, by-product polyethylene waxes and Fischer-Tropsch waxes. Modified waxes, such as vinyl acetate-modified and maleic anhydride-modified waxes may also be used.

Notable paraffin waxes have a ring and ball softening point of about 55° C. to about 85° C. Paraffin waxes include OKERIN 236 TP available from Astor Wax Corporation, Doraville, Ga.; PENRECO 4913 available from Pennzoil Products Co., Houston, Tex.; R-7152 Paraffin Wax available from Moore & Munger, Shelton, Conn.; and Paraffin Wax 1297 available from International Waxes, Ltd in Ontario, Canada. Other notable paraffin waxes have melting points in the range of about 55 to 75° C., such as, for example, PACEMAKER available from Citgo, and R-2540 available from Moore and Munger, and low melting synthetic Fischer-Tropsch waxes having a melting point of less than about 80° C. Particularly notable is paraffin wax with a melting point of about 65° C. Other paraffinic waxes include waxes available from CP Hall (Stow, Ohio) under the product designations 1230, 1236, 1240, 1245, 1246, 1255, 1260 and 1262.

The compositions may also include antioxidants. The antioxidants, if used, are generally present in amounts of about 0.1 to 1.5 weight percent, preferably 0.25 to 1.0 weight percent. Such antioxidants are commercially available from Ciba-Geigy, Hawthorne, N.Y. and include Irganox® 565, 1010 and 1076 which are hindered phenols. These are primary antioxidants which act as radical scavengers and may be used alone or in combination with other antioxidants such as phosphite antioxidants like Irgafos® 168 available from Ciba-Geigy. Phosphite catalysts are considered secondary catalysts and are not generally used alone. These are primarily used as peroxide decomposers. Other available catalysts are Cyanox® LTDP available from Cytec Industries in Stamford, Conn., and Ethanox® 1330 available from Albemarle Corp. in Baton Rouge, La. Many such antioxidants are available either to be used alone or in combination with other such antioxidants. These compounds are added to the composition in small amounts and have no effect on other physical properties. Other compounds that could be added that also do not affect physical properties are pigments which add color, or fluorescing agents, to mention only a couple. Additives like these are known to those skilled in the art. The performance of the antioxidants may be further enhanced by utilizing, in conjunction therewith, known synergists such as, for example, thiodipropionate esters and phosphites. Distearylthiodipropionate is particularly useful.

### Pressure Sensitive Adhesive

Certain features of illustrative embodiments of the PSA tapes disclosed herein are a higher tensile strength and weft strength that enable a cleaner tear line, a higher bond strength to the paper board substrate, and ability to apply the PSA tape at the dry end of a corrugators, in a folder gluer apparatus, or a folding carton press.

Generally, the PSA portion of the tear tape is configured to facilitate secure attachment of the tape to a paper board substrate. The PSA can be a solvent-based adhesive, a water-based adhesive or a hot melt adhesive. Examples of suitable PSA base polymers include rubber pressure-sensitive adhesives containing any of the natural rubbers and synthetic rubbers as a base polymer, acrylic pressure-sensitive adhesives containing, as a base polymer, an acrylic polymer (homopolymer or copolymer) composed of one or more monomer components selected from alkyl esters of (meth)acrylic acids (e.g., alkyl esters whose alkyl moiety having 1 to 20 carbon atoms, such as methyl ester, ethyl ester, propyl ester, isopropyl ester, butyl ester, isobutyl ester, s-butyl ester, t-butyl ester, pentyl ester, hexyl ester, heptyl ester, octyl ester, 2-hydroxyethyl ester, 2-ethylhexyl ester, isooctyl ester, isodecyl ester, dodecyl ester, tridecyl ester, pentadecyl ester, hexadecyl ester, heptadecyl ester, octadecyl ester, nonadecyl ester, and eicosyl ester); vinyl alkyl ether pressure-sensitive adhesives; silicone pressure-sensitive adhesives; polyester pressure-sensitive adhesives; polyamide pressure-sensitive adhesives; urethane pressure-sensitive adhesives; styrenic block copolymer pressure-sensitive adhesives; and pressure-sensitive adhesives having improved creep properties and corresponding to these pressure-sensitive adhesives, except for further containing a tackifying resin having a melting point of about 200° C. or below.

In certain embodiments, the pressure sensitive adhesive is a hot melt pressure sensitive adhesive that includes a styrenic block copolymer as the base polymer. Suitable styrenic block copolymers include those having end-blocks of styrene and a rubbery mid-block of butadiene, isoprene, ethylene/propylene, ethylene/butylene and combinations thereof. Styrenic block copolymers are available in a variety of structures including, e.g., A-B-A triblock structures, A-B diblock structures, (A-B)ₙ radial block copolymer structures, and branched and functional versions thereof, wherein the A endblock is a non-elastomeric polymer block that includes, e.g., polystyrene, vinyl or a combination thereof, and the B block is an unsaturated conjugated diene or hydrogenated version thereof. Examples of suitable B blocks include isoprene, butadiene, ethylene/butylene (hydrogenated butadiene), ethylene/propylene (hydrogenated isoprene) and combinations thereof.

In certain embodiments, the pressure sensitive adhesive is a hot melt pressure sensitive adhesive that includes a styrene-isoprene-styrene block copolymer. Useful commercially available styrene-isoprene-styrene block copolymers include KRATON D1111 and KRATON D1119 available from Kraton Polymers U.S. LLC (Houston, Tex.).

The pressure-sensitive adhesive may further contain other components in addition to the base polymer. Examples of such other components include crosslinking agents such as polyisocyanates and alkyl-etherified melamine compounds; tackifiers such as rosin derivative resins (e.g. wood rosin, tall oil, gum rosin, and rosins esters), natural and synthetic polyterpene resins and derivatives thereof, petroleum resins (e.g. aliphatic, aromatic and mixed aliphatic aromatic), hydrocarbon resins (e.g. alpha-methyl styrene resins, branched and unbranched C5 resins, C9 resins, C10 resins as well as styrenic and hydrogenated modifications of such, and oil-soluble phenol resins; plasticizers (e.g. liquid or solid plasticizers including e.g. hydrocarbon oils, polybutene, liquid tackifying resins, liquid elastomers and benzoate plasticizers); fillers; age inhibitors; and other suitable additives. Independently, the pressure-sensitive adhesive may further contain glass beads or resin beads. The addition of such glass or resin beads may facilitate the control of pressure-sensitive adhesive properties and shear moduli.

### The Fibrous Material

The fibrous material may be in the form of a woven or nonwoven web, a fiber-reinforced film, a multifilament yarn, a monofilament, or any combination thereof. The fibers of the fibrous material may be continuous strands (e.g., a multifilament yarn or a monofilament) unidirectionally oriented in a direction parallel to the length of the tape. Examples of fibrous materials include polyester fiber, polyester film, polyamide fiber (e.g., aromatic polyamide such as KEVLAR fiber from E.I. du Pont or non-aromatic polyamide such as nylon), polypropylene fiber, polyethylene fiber, fiberglass, natural fibers such as cotton or hemp, and/or other similar materials. In certain embodiments the fibrous material is polyester fiber. In certain embodiments, the fibrous material is present in the fibrous material-containing composition in an amount of 10 to 25, particularly 13 to 22, and more particularly 16 to 29 weight percent, based on the total weight of the fibrous material-containing composition. In certain embodiments, the fibrous material has a denier of 300 to 600 per mm of tape width.

In certain embodiments, the PSA tape has a tensile strength of at least 9 kg, more particularly at least 11 kg, and most particularly at least 14 kg, per 6 mm width of tape or 2.3 kg/mm of tape width. In certain embodiments the PSA tape has a weft strength of at least 0.5, more particularly at least 1.4 kg. In certain embodiments the PSA tape applied to a paper board substrate may have a peel strength sufficient to result in paper tear of the paper board substrate (e.g., a minimum peel strength of at least 0.44 kg/cm). The PSA tape also is nick or puncture resistant because the tens, hundreds, or thousands of individual fiber strands prevent propagation of an initial nick or puncture. In certain embodiments, the PSA tape may have a total basis strand weight of 1.60 to 4.2, more particularly 1.9 to 3.6, and most particularly 2.0 to 3.5, g/linear m based on a 12 mm tape width. In certain embodiments, the PSA tape may have a thickness of 0.228 to 0.382 mm, more particularly 0.254 to 0.342 mm, prior to adhesion to the paper board. In some embodiments, the PSA tape can have a length longer than its width. In other words, the PSA tape defines a longitudinal axis along a longitudinal direction. In specific embodiments, the width of the PSA tape is 2 mm to 52 mm, more particularly 3 mm to 25 mm, and most particularly 4 to 12 mm.

The tape may be made by applying the desired composition (e.g., the first hot melt composition, the second hot melt composition, the plastic composition, or the PSA composition) in a molten hot state to the fibrous material substrate in the desired order while the fibrous substrate is under tension at a controlled speed. The molten composition(s) are allowed to cool and set up as a solid forming a linear unitized tape. The tape production process may include any heating methods known for applying hot melt adhesives.

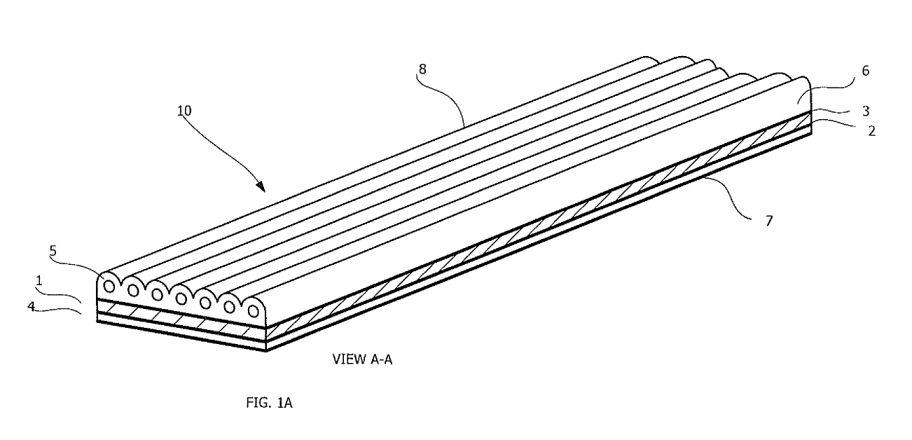

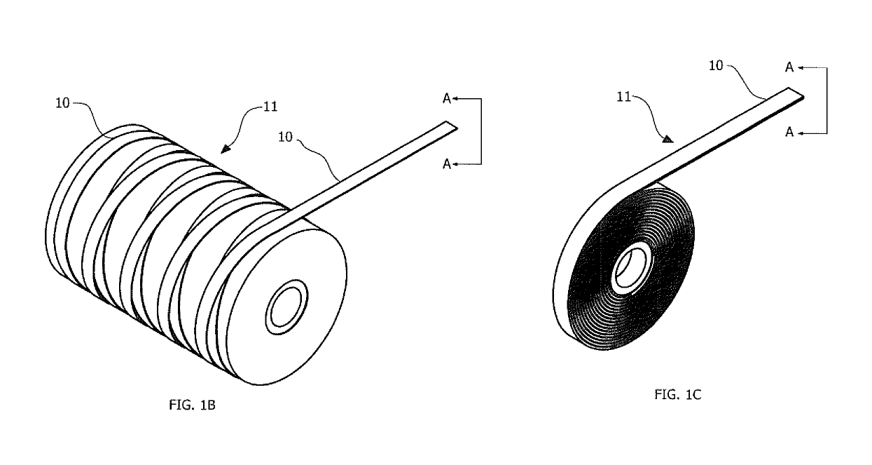

A first embodiment of a PSA tape 10 disclosed herein is shown in FIG. 1A. The PSA tape 10 includes a first hot melt layer 1 that defines a first surface 2 and an opposing second surface 3. The first hot melt layer 1 is made from the above-described first hot melt composition. A pressure sensitive adhesive 4 contacts the first surface 2 of the first hot melt layer 1. The pressure sensitive adhesive 4 may be a layer that covers all, or only a portion thereof, of the area of the first surface 2. A fibrous substrate 5 is disposed on, or near, the second surface 3 of the first hot melt layer 1. The fibrous substrate 5 may, or may not, contact the second surface 3. The fibrous substrate 5 is encapsulated by a second hot melt composition 6. The encapsulating hot melt composition is made from the above-described second or release hot melt composition. As used herein, “encapsulation” is inclusive of coating the entire circumferential and longitudinal surface of the fiber, or only a portion of the circumferential and longitudinal surface of the fibers. For example, the composition 6 may completely coat the entire circumferential surface of the fibers so that the composition is present in an area between the fibers 5 and the second surface 3 of the first hot melt layer 1. Alternatively, the composition 6 only coats a portion of the circumferential surface of the fibers. In one embodiment, the fibers contact the second surface 3 of the first hot melt layer 1 and the composition 6 only coats the portion of the fiber surface not in contact with the second surface 3. The composition 6 also may or may not impregnate the fibers. The encapsulating hot melt composition 6 includes a release agent as described above. Thus, the tape 10 defines a first surface 7, which is a pressure sensitive adhesive, and an opposing second surface 8, which is not a pressure sensitive adhesive. The fiber-encapsulating composition 6 forms one outer layer of the tape 10, and the pressure sensitive adhesive 4 forms the other outer layer of the tape 10.

In the embodiment of FIG. 1A the first hot melt layer 1 provides weft strength to the tape, provides a barrier between the PSA 4 and the release agent-containing layer, provides a smooth surface for the PSA 4 to bond to, may also further encapsulate the fibrous substrate 5, and provides a bond to the encapsulated fibrous substrate 5. The amounts of material in each layer of the tape of FIG. 1A may vary. In certain embodiments, the encapsulating composition 6 (i.e., the release agent-containing hot melt composition) is present in an amount of 38 to 97, more particularly 48 to 81 g/m², the fibrous material is present in an amount of 47 to 103, more particularly 59 to 86, g/m², the first hot melt layer 1 is present in an amount of 24 to 82, more particularly 30 to 68, g/m², and the PSA 4 is present in an amount of 25 to 103, more particularly 32 to 86, g/m².

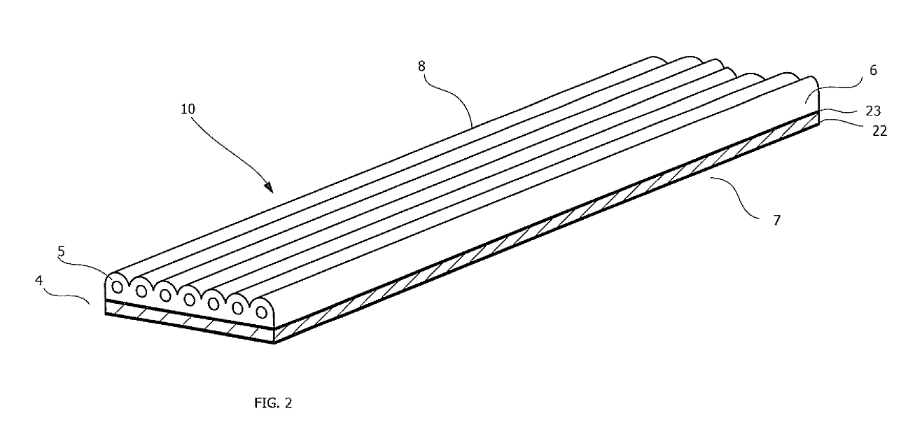

A second embodiment of a PSA tape 10 disclosed herein is shown in FIG. 2. The PSA tape 10 includes a PSA layer 4 that defines a first surface 22 and an opposing second surface 23. The pressure sensitive adhesive 4 may be a layer that covers all, or only a portion thereof, of the area of the second surface 23. Fibrous material 5 is disposed on, or near, the second surface 23 of the PSA 4. The fibers may, or may not, contact the second surface 23. The fibrous substrate 5 is encapsulated by a second hot melt composition 6. The encapsulating hot melt composition is made from the above-described second or release hot melt composition. As used herein, “encapsulation” is inclusive of coating the entire circumferential and longitudinal surface of the fiber, or only a portion of the circumferential and longitudinal surface of the fibers. For example, the composition 6 may completely coat the entire circumferential surface of the fibers so that the composition is present in an area between the fibers 5 and the second surface 23 of the PSA 4. Alternatively, the composition 6 only coats a portion of the circumferential surface of the fibers. In one embodiment, the fibers contact the second surface 23 of the PSA 4 and the composition 6 only coats the portion of the fiber surface not in contact with the second surface 23. The composition 6 also may or may not impregnate the fibers. The encapsulating hot melt composition 6 includes a release agent as described above. Thus, the tape 10 defines a first surface 7, which is a pressure sensitive adhesive, and an opposing second surface 8, which is not a pressure sensitive adhesive. The fiber-encapsulating composition 6 forms one outer layer of the tape 10, and the pressure sensitive adhesive 4 forms the other outer layer of the tape 10.

In the embodiment of FIG. 2, the amount of the encapsulating composition 6 (i.e., the release agent-containing hot melt composition) is present in an amount of 51 to 142, more particularly 64 to 118, g/m², the fibrous material is present in an amount of 47 to 103, more particularly 59 to 86, g/m², and the PSA 4 is present in an amount of 25 to 114, more particularly 32 to 95, g/m².

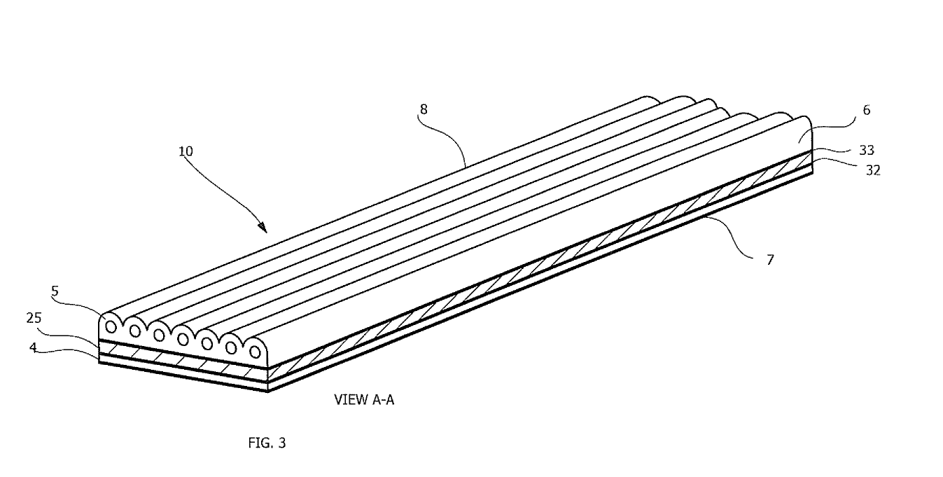

A third embodiment of a PSA tape 10 disclosed herein is shown in FIG. 3. The PSA tape 10 includes a plastic layer 25 that defines a first surface 32 and an opposing second surface 33. The plastic layer 25 is made from the above-described plastic composition. A pressure sensitive adhesive 4 is disposed on the first surface 32 of the plastic layer 25. The pressure sensitive adhesive 4 may be a layer that covers all, or only a portion thereof, of the area of the first surface 32. Fibrous material 5 is disposed on, or near, the second surface 33 of the plastic layer 25. The fibers may, or may not, contact the second surface 33. The fibrous substrate 5 is encapsulated by a second hot melt composition 6. The encapsulating hot melt composition is made from the above-described second or release hot melt composition. As used herein, “encapsulation” is inclusive of coating the entire circumferential and longitudinal surface of the fiber, or only a portion of the circumferential and longitudinal surface of the fibers. For example, the composition 6 may completely coat the entire circumferential surface of the fibers so that the composition is present in an area between the fibers 5 and the second surface 33 of the plastic layer 25. Alternatively, the composition 6 only coats a portion of the circumferential surface of the fibers. In one embodiment, the fibers contact the second surface 33 of the plastic layer 25 and the composition 6 only coats the portion of the fiber surface not in contact with the second surface 33. The composition 6 also may or may not impregnate the fibers. The encapsulating hot melt composition 6 includes a release agent as described above. Thus, the tape 10 defines a first surface 7, which is pressure sensitive adhesive, and an opposing second surface 8, which is not a pressure sensitive adhesive. The fiber-encapsulating composition 6 forms one outer layer of the tape 10, and the pressure sensitive adhesive 4 forms the other outer layer of the tape 10.

In the embodiment of FIG. 3 the plastic layer 25 provides weft strength to the tape, provides a barrier between the PSA 4, and provides a smooth surface for the PSA 4 to bond to. The amounts of material in each layer of the tape of FIG. 3 may vary. In certain embodiments, the encapsulating composition 6 (i.e., the release agent-containing hot melt composition) is present in an amount of 38 to 97, more particularly 48 to 81, g/m², the fibrous material is present in an amount of 47 to 103, more particularly 59 to 86, g/m², the plastic layer 25 is present in an amount of 24 to 82, more particularly 30 to 68, g/m², and the PSA 4 is present in an amount of 25 to 103, more particularly 32 to 86, g/m².

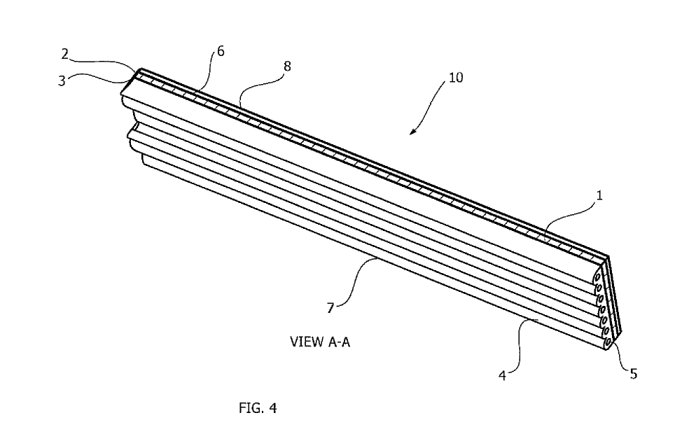

A fourth embodiment of a PSA tape 10 disclosed herein is shown in FIG. 4. The PSA tape 10 includes a first hot melt composition layer 1 that defines a first surface 2 and an opposing second surface 3. The first hot melt composition layer 1 is made from the above-described first hot melt composition. A release agent-containing hot melt composition forms a layer 6 that is disposed on the first surface 2 of the hot melt composition layer 1. The composition 6 is hot melt composition that includes a release agent as described above. A fibrous substrate 5 is disposed on the second surface 3 of the hot melt composition layer 1. The fibers may, or may not, contact the second surface 3. The fibers are encapsulated by a pressure sensitive adhesive 4. Thus, the tape 10 defines a first surface 7, which is a pressure sensitive adhesive, and an opposing second surface 8, which is not a pressure sensitive adhesive. The composition 6 forms one outer layer of the tape 10, and the pressure sensitive adhesive 4 forms the other outer layer of the tape 10.

In the embodiment of FIG. 4 the first hot melt layer 1 provides weft strength to the tape, provides a barrier between the PSA 4 and the release agent-containing layer, provides a smooth surface for the PSA to bond to, may also further encapsulate the fibrous substrate 5, and provides a bond to the encapsulated fibrous substrate 5. The amounts of material in each layer of the tape of FIG. 4 may vary. In certain embodiments, the encapsulating composition 4 (i.e., the PSA) is present in an amount of 30 to 137, more particularly 38 to 115, g/m², the fibrous material is present in an amount of 47 to 103, more particularly 59 to 86, g/m², the first hot melt layer 1 is present in an amount of 26 to 42, more particularly 33 to 35, g/m², and the release agent-containing composition layer 6 is present in an amount of 51 to 141, more particularly 64 to 118, g/m².

The tape 10 may be provided in the form of a roll 11 as shown, for example, in FIGS. 1B and 1C. In the embodiment shown in FIG. 1B the tape 10 is wound upon itself in an arrangement in which an outer length of tape 10 is aligned at an angle, particularly an acute angle, relative to an inner length of tape 10 upon which the outer length is disposed. In other words, each successive wind of the tape 10 traverses the previous, or underlying, tape 10 wind at an angle, particularly an acute angle. The FIG. 1B embodiment is an example of a “traverse wound roll.” In the embodiment shown in FIG. 1C the tape 10 is would upon itself so that each successive wind of the tape 10 is aligned parallel to the previous, or underlying, tape 10 wind. The FIG. 1C embodiment is an example of a “pancake wound roll.” When the tape is in the form of roll, the pressure sensitive adhesive layer 4 of a first length of the tape contacts the release agent-containing composition 6 of a second length of tape overlaying the first length of the tape.

### Substrate with PSA Tape

The PSA tape may be applied to any type of paper board substrate. In certain embodiment, the substrate may be a corrugated paper board. The corrugated board substrate includes an exterior liner and a corrugated member. In some implementations, the corrugated member consists of a series of parallel flutes. However, in other implementations, the corrugated member can include other configurations, such as a waffle-type pattern or honeycomb. The corrugated paper board may be a single wall structure (i.e., includes a single fluted corrugated medium and at least one liner layer) or a multiwall structure (i.e., includes at least two fluted corrugated mediums and at least one liner layer). One or more substrates can form an article of manufacture such as a packaging container. Examples of packaging containers include cartons and boxes, such as cartons for holding beverages for sale at the retail level (for instance, a hand-carry carton that holds six, 12 or 24 bottles or cans of a beverage), meat and produce bulk bins, wet-packed containers, reusable containers, rubber and chemical bulk bins, heavy duty containers, bags, and envelopes. A continuous corrugated board substrate can be manufactured by bonding the corrugated member to the exterior liner using an adhesive, and subjecting the exterior liner and corrugated member to heat.

The PSA tape may be used as a tear tape for opening an article, such as a container, made from a paper board substrate. The PSA tape may be used in one-tape opening systems or multi-tape opening systems (e.g., a two-tape opening system). Tape opening systems can also provide reinforcement of a container substrate while facilitating effective opening of the container. Multi-tape opening systems typically include at least two tapes—a tear tape and a guide tape. The presently disclosed PSA tape may be utilized as the tear tape with another type of a tape as the guide tape, or both the tear tape and the guide tape may be the PSA tapes.

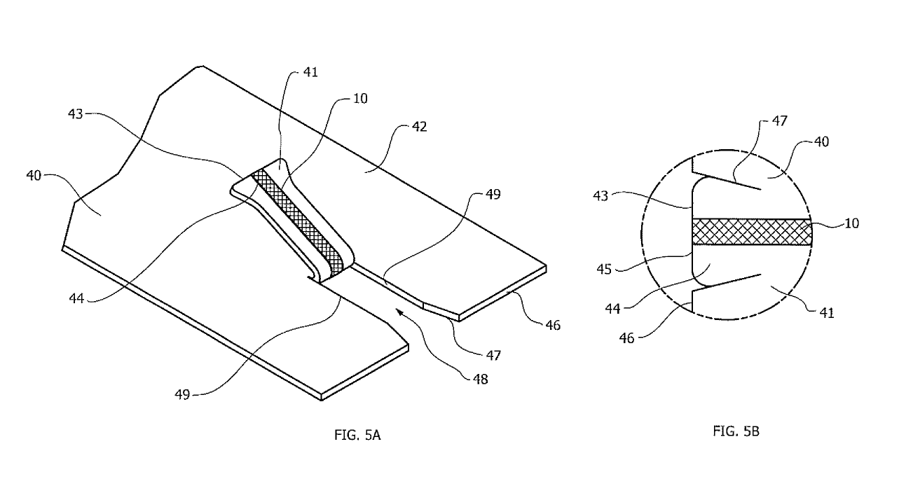

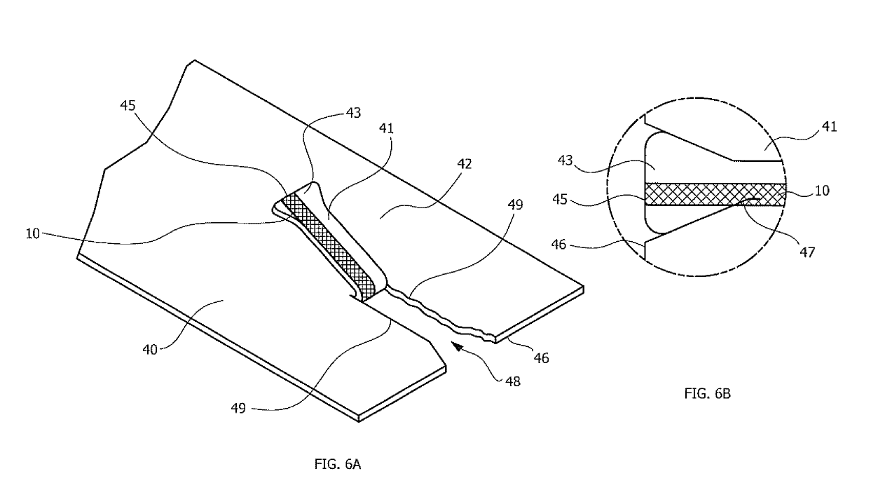

FIGS. 5A and 5B, and FIGS. 6A and 6B, show embodiments of a one-tape tear opening system. The tape 10 is adhesively secured to a first surface 41 of a paper board substrate 40. The first surface 7 of the tape 10 defined by the PSA layer 4 contacts the first surface 41 of the paper board substrate 40 so that the tape 10 is adhesively secured to the paper board substrate 40. The paper board substrate 40 also includes a second surface 42 opposing the first surface 41. A tear tab 43 is formed in the paper board substrate 40. In certain embodiments the tear tab 43 has a flared handle portion 44 at its tear-initiating end 45 that enables a user to grip and pull the tear tab 43. The tear-initiating end 45 of the tear tab 43 may be located at an edge of the paper board substrate.

In certain embodiments the tear tab 43 may be made by cutting a profile or pattern that extends through the entire thickness of the paper board substrate 40 and that matches the profile or pattern of the tear tab 43. The cut 47 for the tear tab 43 is made during the converting of the paper board substrate into a container so that the cut 47 and associated tear tab 43 are present in the finished container made from the paper board substrate. In the embodiment shown in FIGS. 5A and 5B, the cut 47 does not cut into the tape 10. In the embodiment shown in FIGS. 6A and 6B the cut 47 also extends into a portion of the tape 10.

The paper board substrate 40 with the tear tape 10 may be formed into a container. The first surface 41 of the paper board substrate 40 that carries the tape 10 forms the interior surface of the container, and the opposing second surface 42 of the paper board substrate 40 forms the exterior surface of the container. Because of the cut 47 extending through the entire thickness of the paper board substrate 40, a user can grip the tear tab 43 and pull on the tear tab 43 to open the container along desired tear lines 49. For example, FIGS. 5A and 6A show a tear opening 48 forming in the paper board substrate 40. The tear opening 48 can be extended a desired distance to open the container. For example, the tear tape 10 may be horizontally disposed around the peripheral circumference of a container thereby dividing the container into an upper section and a lower section.

FIG. 7 shows an embodiment in which tape 10 is disposed on the first surface 41 of a paper board substrate 40. PSA layer 4 of tape 10 is adhesively secured to the first surface 41 of the paper board substrate 40. In this embodiment the paper board substrate is a corrugated board substrate that includes a fluted or corrugated inner medium 60 disposed between inner liner 61 and outer liner 62.

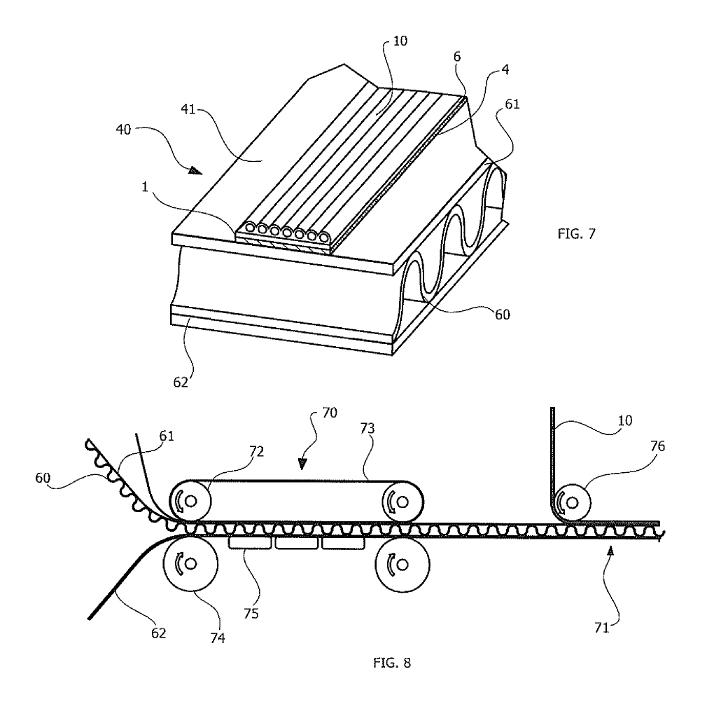

A continuous corrugated board substrate that includes tape 10 may be made, for example, by the process shown in FIG. 8. FIG. 8 shows a corrugator having a wet end segment 70 and a dry end segment 71. Inside liner 61 adhered to the flutes of one side of the corrugated medium 60 is fed between pressure rolls 72 driving a pressure belt 73. An outside liner 62 is applied to the opposing flutes of corrugated medium 60 by being fed into the nip of roller 74. Thus, outside liner 62, corrugated medium 60, and inside liner 61 are sandwiched between pressure belt 73 and hot plates 75. Upstream from the rollers 72 and 74, an adhesive is applied to the flutes of the corrugated medium 60, which is heat activated so that when the three elements pass between pressure belt 73 and hot plates 75, the outside liner is firmly adhered to the corrugated member 60.

In the dry end segment 71 of the corrugator, tape 10 is applied to the outside surface of the inner liner 61. In the embodiment shown in FIG. 8, pressure is applied via a roller 76 so that the PSA surface of the tape 10 adheres to the outside surface of the inner liner 61. When paper board substrate 40 is formed into a container, the outside surface of the inner liner 61 becomes the interior surface of the container. Thus, tear tape 10 lies on the interior surface of the container.

The PSA tape disclosed herein also may be applied to a paper board substrate in a non-continuous manner. For example, the PSA tape may be applied intermittently at predetermined locations to the paper board substrate. In other words, a predetermined length of the PSA tape is applied at each location with a predetermined gap between the lengths of the PSA tape.

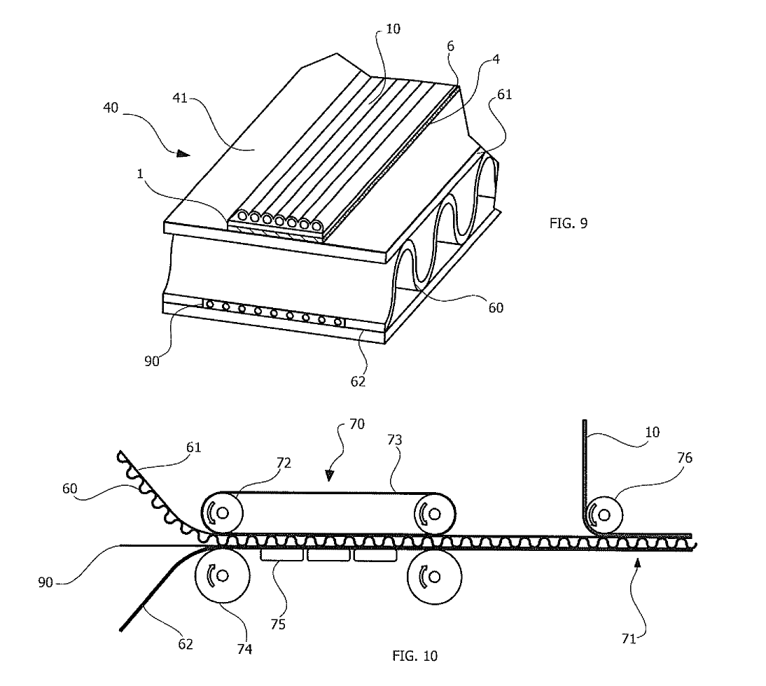

FIG. 9 shows an embodiment of a two-tape tear opening system in which one of the tapes is the PSA tape disclosed herein. More specifically, PSA tape 10 is disposed on the first surface 41 of a paper board substrate 40. PSA layer 4 of tape 10 is adhesively secured to the first surface 41 of the paper board substrate 40. In this embodiment the paper board substrate is a corrugated board substrate that includes a fluted or corrugated inner medium 60 disposed between inner liner 61 and outer liner 62. A second tape 90, which is a guide tape, is disposed within the paper board substrate 40. The second tape 90 may be located between the outer liner 62 and the corrugated medium 60, or the second tape 90 may be located between the inner liner 61 and the corrugated medium 60. As described above, the paper board substrate 40 with the tear tape 10 and second tape 90 may be formed into a container. The first surface 41 of the paper board substrate 40 that carries the tape 10 forms the interior surface of the container, and the opposing second surface 42 of the paper board substrate 40 forms the exterior surface of the container.

The second tape 90 may be a heat-activatable tape. For example, second tape 90 may be a hot melt adhesive coated tape or string, which may or may not be reinforced with unidirectional fibers aligned parallel to the length direction of the tape or string. The second tape 90 is aligned parallel to the PSA tape 10 and underlies (i.e., is juxtaposed with) the PSA tape 10. The tapes 10 and 90 can be sized to have the same or different widths. In certain embodiments, the second tape 90 is wider compared to tape 10.

The second tape 90 is a guide tape that has no weft or cross machine direction strength. This lack of weft strength in guide tape 90 together with strength in the machine direction allows tearing of the guide tape along the tear lines while simultaneously maintaining edge reinforcing therealong. Thus, by grasping tear tab 43 formed by tear tab cut 47 and pulling the same in the longitudinal direction of tear tape 10 and guide tape 90, tear tape 10 tears through the material of paper board substrate 40 substantially coincident with tear tape 10 and also tears along guide tape 90 which guides the tear and provides edge reinforcing resulting in substantially even tear lines 49. In certain embodiments, the guide tape 90 may be located on the second surface 42 of the paper board substrate 40 rather than embedded within the paper board substrate. Thus, when the paper board substrate is formed into a container, the guide tape 90 is disposed on the exterior surface of the container.

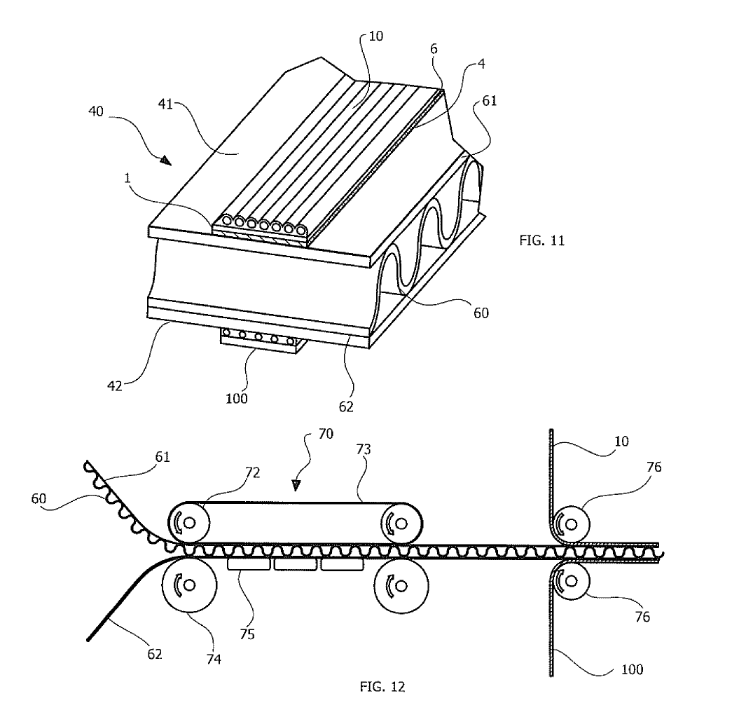

Guide tape 90 is applied to the inside surface of outside liner 62 by feeding it into the nip of the pressure roll 72 and roller 74 between outside liner 26 and corrugated medium 60 (see FIG. 10).

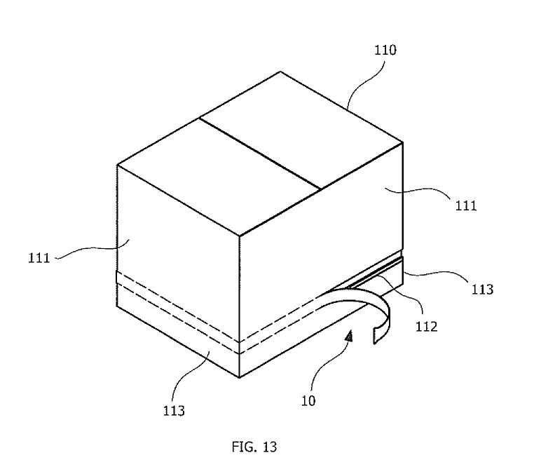

FIG. 11 shows an embodiment of a two-tape tear opening system in which both of the tapes are the PSA tapes disclosed herein. More specifically, a first PSA tape 10 is disposed on the first surface 41 of a paper board substrate 40. PSA layer 4 of tape 10 is adhesively secured to the first surface 41 of the paper board substrate 40. A second PSA tape 20 is disposed on the second surface 42 of the paper board substrate 40. PSA layer 4 of tape 20 is adhesively secured to the second surface 42 of the paper board substrate 40. In this embodiment the paper board substrate is a corrugated board substrate that includes a fluted or corrugated inner medium 60 disposed between inner liner 61 and outer liner 62. The second PSA tape 20 serves as a guide tape as described above in connection with tape 90. FIG. 12 depicts a method of applying both PSA tapes 10, 20 onto the paper board substrate via pressure rollers 76.

FIG. 13 shows a container 110 that includes a PSA tear tape 10. Pulling on the PSA tear tape 10 creates a tear opening 112 that divides the container 110 into a top section 11 and a bottom section 113.

### EXAMPLES

### Examples

### First Hot Melt Composition Embodiments

### Example #1

0.33% Antioxidant, 0.14% Blue dye, 30% Rosin Ester by Mead WestVaco Westerez 5101, 13% Hicotack P-120P Phenolic Resin, 5% Polyethylene Homopolymer Honeywell AC-6, 11% Paraffin Wax 140 melt point IGI 1240, 31.86% Ethylene Vinyl Acetate 2810 Atevea AT plastics, 9% Ethylene Vinyl Acetate 1880 Ateva AT Plastics.

### Example #2

0.33% Antioxidant BNX 1010, 0.14% Blue Dye Solvent Blue 35, 26.03% Komotac KF454s Guangdong Komo, 15% Hikotack P-110S, 17.5% Wax IGI 1240, 33% Dupont Elvax 260, 8% Dupont Elvax 150.

### Example #3

0.33% Antioxidant BNX 1010, 0.14% Blue Dye Solvent Blue 35 Paramount Colors, 32% Sylvatlite RE100L Arizona Chemical, 12% Sylvares TP2040 Arizona Chemical, 12% Marcus 300 Marcus Oil & Chemical, 2.53% Polywax 2000 Polyethylene Baker Petrolite, 5% AC-6 Polyethylene Homopolymer Honeywell, 9% Ethylene Vinyl Acetate Elvax 260, 27% Ethylene Vinyl Acetate Elvax 410.

### Example #4

0.33% Antioxidant BNX 1010, 0.14% Blue Dye Solvent Blue 35 Paramount Colors, 30% Komotack KF454S Guangdong Komo, 10% Hicotack P-120P Kolon Chemical, 5% AC-6 Polyethylene Homopolymer Honeywell, 2.53% Honeywell AC 820A Honeywell, 10% Marcus 200 Marcus Oil & Chemical, 1% Rubber, 14% SIS, 10% Coupled Kraton D1161K (85% rubber), 37% Ethylene Vinyl Acetate Ateva 2810.

### Example #5

0.33% Antioxidant Evernox 10GF, 0.14% Blue Dye Solvent Blue 35 Paramount Colors, 33.67% Sylvatlite RE100L Arizona Chemical, 12.86% Sylvares TP2040 Arizona Chemical, 12% Marcus 300 Marcus Oil & Chemical, 3% Polywax 2000 Polyethylene Baker Petrolite, 7% Ethylene Vinyl Acetate Elvax 410, 31% Ethylene Vinyl Acetate Elvax 260.

### Example #6

0.33% Antioxidant BNX 1010, 0.14% Blue Dye Solvent Blue 35 Paramount Colors, 32% Westrez 5101 Mead Westvaco, 12% Hicotack P-120P Kolon Chemical, 6% Marcus 300 Marcus Oil & Chemical, 2.5% Polywax 2000 Polyethylene Baker Petrolite, 5% Shell SX100 Baker Petrolite, 7% Ethylene Vinyl Acetate Ateva 1880A, 8.03% Ethylene Vinyl Acetate Elvax 150, 27% Ethylene Vinyl Acetate Ateva 2810.

### Example #7

0.33% Antioxidant Evernox 10GF, 0.14% Blue Dye Solvent Blue 35 Paramount Colors, 32% Sylvatlite RE100L Arizona Chemical, 12% Sylvares TP2040 Arizona Chemical, 5% AC-6 Polyethylene Homopolymer Honeywell, 2.53% Polywax 2000 Polyethylene Baker Petrolite, 6% Marcus 300 Marcus Oil & Chemical, 15% Ethylene Vinyl Acetate Elvax 410, 27% Ethylene Vinyl Acetate Elvax 260.

### Example #8

0.33% Antioxidant Evernox 10GF, 0.14% Blue Dye Solvent Blue 35 Paramount Colors, 32% Sylvatlite RE100L Arizona Chemical, 12% Sylvares TP2040 Arizona Chemical, 5% AC-6 Polyethylene Homopolymer Honeywell, 2.53% Polywax 2000 Polyethylene Baker Petrolite, 6% Marcus 300 Marcus Oil & Chemical, 27% Ethylene Vinyl Acetate Elvax 410, 15% Ethylene Vinyl Acetate Elvax 260.

### Example #9

0.5% Antioxidant Evernox 100GF, 0.2% Blue Dye Solvent Blue 35 Paramount Colors, 20% Westrez 5101 Mead Westvaco, 21% Hicotack P-120P Kolon Chemical, 10% Sasolwax HI, 15% Marcus 200 Marcus Oil & Chemical, 2.4% Honeywell AC 820A Honeywell, 30.9% Ethylene Vinyl Acetate Elvax 150.

### Example #10

0.33% Antioxidant BNX 1010, 0.14% Blue Dye Solvent Blue 35 Paramount Colors, 29.25% Westrez 5101 Mead Westvaco, 11% Hicotack P-120P Kolon Chemical, 5% AC-6 Polyethylene Homopolymer Honeywell, 4% Sasolwax HI, 11.53% Paraffin 1240, 24.75% Ethylene Vinyl Acetate Ateva 2810, 14% Ethylene Vinyl Acetate Ateva 1880A.

### Example #11

0.33% Antioxidant BNX 1010, 0.14% Blue Dye Solvent Blue 35 Paramount Colors, 29.25% Komotack KF454S Guangdong Komo, 11% Hicotack P-120P Kolon Chemical, 5% AC-6 Polyethylene Homopolymer Honeywell, 4% Shell SX100 Baker Petrolite, 11.53% Wax IGI Paraffin 1260A, 24.75% Ethylene Vinyl Acetate Ateva 2810, 14% Ethylene Vinyl Acetate Ateva 1880A.

### Example #12

0.33% Antioxidant Evernox 10GF, 0.14% Blue Dye Solvent Blue 35 Paramount Colors, 31.25% Sylvatlite RE100L Arizona Chemical, 11% Sylvares TP2040 Arizona Chemical, 5% AC-6 Polyethylene Homopolymer Honeywell, 2.53% Sasolwax H8, 10% Wax Sasolwax R4054, 25.75% Ethylene Vinyl Acetate Elvax 260, 14% Ethylene Vinyl Acetate Elvax 410.

### Example #13

0.33% Antioxidant BNX 1010, 0.14% Blue Dye Solvent Blue 35 Paramount Colors, 32% Westrez 5101 Mead Westvaco, 12% Hicotack P-120P Kolon Chemical, 9.53% Sasolwax C80, 5% AC-6 Polyethylene Homopolymer Honeywell, 27% Ethylene Vinyl Acetate Ateva 2810, 14% Ethylene Vinyl Acetate Ateva 1880A.

### Example #14

0.33% Antioxidant Evernox 10GF, 0.14% Blue Dye Solvent Blue 35 Paramount Colors, 33.5% Komotack KF454S Guangdong Komo, 7.53% Hicotack P-110S, 19.25% Shell SX100 Baker Petrolite, 27.25% Ethylene Vinyl Acetate Elvax 260, 12% Ethylene Vinyl Acetate Elvax 150.

### Example #15

0.33% Antioxidant BNX 1010, 0.14% Blue Dye Solvent Blue 35 Paramount Colors, 34% Sylvatlite RE100L Arizona Chemical, 10% Sylvares TP2040 Arizona Chemical, 9.53% Sasolwax HI, 5% AC-6 Polyethylene Homopolymer Honeywell, 27% Ethylene Vinyl Acetate Ateva 2810, 14% Ethylene Vinyl Acetate Ateva 3325.

### Example #16

0.33% Antioxidant Evernox 10GF, 0.14% Blue Dye Solvent Blue 35 Paramount Colors, 36% Komotack KF454S Guangdong Komo, 8% Hicotack P-110S, 5% AC-6 Polyethylene Homopolymer Honeywell, 9.53% Shell SX 100 Baker Petrolite, 27% Ethylene Vinyl Acetate Elvax 260, 14% Ethylene Vinyl Acetate Elvax 150.

### Example #17

0.33% Antioxidant Evernox 10GF, 0.14% Blue Dye Solvent Blue 35 Paramount Colors, 38% Komotack KF454S Guangdong Komo, 6% Hicotack P-110S, 9.53% Shell SX100 Baker Petrolite, 5% AC-6 Polyethylene Homopolymer Honeywell, 27% Ethylene Vinyl Acetate Elvax 260, 14% Ethylene Vinyl Acetate Elvax 150.

### Example #18

0.33% Antioxidant BNX 1010, 0.14% Blue Dye Solvent Blue 35 Paramount Colors, 40% Sylvatlite RE100L Arizona Chemical, 4% Sylvares TP2040 Arizona Chemical, 9.53% Sasolwax H1, 5% AC-6 Polyethylene Homopolymer Honeywell, 27% Ethylene Vinyl Acetate Ateva 2810, 14% Ethylene Vinyl Acetate Ateva 3325.

### Example #19

0.33% Antioxidant Evernox 10GF, 0.14% Blue Dye Solvent Blue 35 Paramount Colors, 20% Komotack KF454S Guangdong Komo, 17.53% Hicotack P-110S, 40% Shell SX100 Baker Petrolite, 10% Ethylene Vinyl Acetate Elvax 260, 12% Ethylene Vinyl Acetate Elvax 150.

### Example #20

0.33% Antioxidant BNX 1010, 0.14% Blue Dye Solvent Blue 35 Paramount Colors, 10% Sylvatlite RE100L Arizona Chemical, 12% Sylvares TP2040 Arizona Chemical, 40% Sasolwax HI, 5% AC-6 Polyethylene Homopolymer Honeywell, 12.53% Ethylene Vinyl Acetate Ateva 2810, 20% Ethylene Vinyl Acetate Ateva 3325.

### Example #21

0.33% Antioxidant BNX 1010, 0.14% Blue Dye Solvent Blue 35 Paramount Colors, 5% AC-6 Polyethylene Homopolymer Honeywell, 40% Westrez 5101 Mead Westvaco, 12% Alphachem SK-120, 10% Wax IGI Paraffin 1260A, 12.53% Rubber, 14% SIS, 14% Coupled Kraton D1161K (85% rubber), 20% Ethylene Vinyl Acetate Ateva 3325.

### Example #22

0.33% Antioxidant Evernox 10GF, 0.14% Blue Dye Solvent Blue 35 Paramount Colors, 5% AC-6 Polyethylene Homopolymer Honeywell, 23% Komotack KF454S Guangdong Komo, 9.53% Rubber, 14% SIS, 84% Coupled Kraton D1161K, 10% Ethylene Vinyl Acetate Elvax 410, 12% Honeywell AC 820A Honeywell, 40% Ethylene Vinyl Acetate Elvax 260.

### Example #23

0.33% Antioxidant Evernox 10GF, 0.14% Blue Dye Solvent Blue 35 Paramount Colors, 80% A Epolene C-18 Polyethylene wax, 20% Ethylene Vinyl Acetate Elvax 260

### Example #24

0.33% Antioxidant Evernox 10GF, 40% Gum Rosin Brazilian, 40% Shell SX100 Baker Petrolite, 20% Ethylene Vinyl Acetate Elvax 260

### Example #25

0.33% Antioxidant Evernox 100GF, 19.67% Sylvatlite RE100L Arizona Chemical, 40% Shell SX100 Baker Petrolite, 20% Ethylene Vinyl Acetate Elvax 260, 20% Ethylene Vinyl Acetate Elvax 3325

### Example #26

0.33% Antioxidant Evernox 10GF, 10% Sylvatlite RE100L Arizona Chemical, 40% Shell SX 100 Baker Petrolite, 20% Ethylene Vinyl Acetate Elvax 260, 19.67% Ethylene Vinyl Acetate Elvax 3325; 10% Optina TC220 Exxon Mobil Chemical

### Example #27

0.33% Antioxidant Evernox 10GF, 21% Eastotac H-130 Eastman Chemical, 40% Shell SX100 Baker Petrolite, 10% Epolene C-13 Eastman Chemical, 28.67% Ethylene Vinyl Acetate Elvax 3325

### Examples

### Second or Release Agent-Containing Hot Melt Compositions

### Example #28

11.65% Honeywell AC 820 A Honeywell Chemical, 0.3 Evernox 10GF, 9% Sylvatlite RE100L Arizona Chemical, 7% Shell SX100 Baker Petrolite, 34% Polymer Metocene MF650W Ashland, Inc., 22% Ethylen Vinyl Acetate Ateva 1880A, 6% Affinity 1900 Dow Chemical Company, 0.05% Blue Dye Solvent Blue 35 Paramount Colors, 10% Acrawax C Beads Pacific Coast Chemical

### Example #29

14.7%, 0.3 Evernox 10GF, 14.0% Coupled Kraton D1161K 9% Sylvatlite RE100L Arizona Chemical, 7% Shell SX100 Baker Petrolite, 24% Polymer Metocene MF650W Ashland, Inc., 20% Ethylene Vinyl Acetate Ateva 1880A, 6% Affinity 1900 Dow Chemical Company, 0.2% Blue Dye Solvent Blue 35 Paramount Colors, 5% Acrawax C Beads Pacific Coast Chemical, 0.1% Tiona RCL-4 Titanium

### Example

### Plastic Composition

### Example #30

7% Shell SX100 wax Baker Petrolite, 60% Polymer Metocene MF650W Ashland, Inc, 32% Affinity 1900 Dow Chemical Company, 0.1% Tiona RCL-4 Titanium, 0.3 Evernox 10GF

### Tape Example 1

Tapes according to the embodiment shown in FIG. 1 were made with polyester fibers, a composition of Example #28 as the composition 6, and compositions of Examples #1-25 as the first hot melt layer 1. The tapes had a tensile strength of 44.72 kg and a weft strength of 1.36 kg.

### Tape Example 2

A tape according to the embodiment shown in FIG. 2 was made with polyester fibers, and a composition of Example #28. The tape had a tensile strength of 44.72 kg and a weft strength of 0.86 kg.

### Tape Example 3

A tape according to the embodiment shown in FIG. 3 was made with polyester fibers, a composition of Example #28 as the composition 6, and a composition of Example #30 as plastic layer 25. The tape had a tensile strength of 34 kg and a weft strength of 1.13 kg.

In view of the many possible embodiments to which the principles of the disclosed invention may be applied, it should be recognized that the illustrated embodiments are only preferred examples of the invention and should not be taken as limiting the scope of the invention.

What is claimed is:

1. A tape comprising:
a first hot melt adhesive composition or plastic composition that provides weft strength to the tape;
a second hot melt adhesive composition that includes a release agent;
an encapsulated fibrous material layer, wherein the fibrous material is encapsulated by (i) the first hot melt adhesive composition or (ii) the second hot melt adhesive composition; and
a pressure sensitive adhesive layer that defines an outer pressure sensitive adhesive surface of the tape;
wherein the first hot melt adhesive composition or plastic composition is located between the second hot melt adhesive composition and the pressure sensitive adhesive layer.

2. The tape of claim 1, wherein the first hot melt adhesive composition has a melt point of at least 90° C. and comprises an ethylene vinyl acetate polymer.

3. The tape of claim 2, wherein the first hot melt adhesive composition further comprises a film-forming polymer.

4. The tape of claim 1, wherein the second hot melt adhesive composition comprises an ethylene vinyl acetate polymer and the release agent comprises an internal release agent having a melting point of at least about 120° C.

5. The tape of claim 4, wherein the second hot melt adhesive composition further comprises a film-forming polymer.

6. The tape of claim 1, wherein the plastic composition comprises a film-forming polymer and at least one wax.

7. The tape of claim 2, wherein the release agent comprises an internal release agent having a melting point of at least about 120° C.

8. The tape of claim 1, wherein the first hot melt adhesive composition forms a layer that defines a first surface and a second surface, the second hot melt adhesive composition encapsulates the fibrous material, the pressure sensitive layer contacts the first surface of the first hot melt adhesive composition layer, and the encapsulated fibrous material layer contacts the second surface of the first hot melt adhesive composition layer.

9. The tape of claim 8, wherein the first hot melt adhesive composition has a melt point of at least 90° C. and comprises an ethylene vinyl acetate polymer.

10. The tape of claim 9, wherein the first hot melt adhesive composition further comprises a film-forming polymer.

11. The tape of claim 8, wherein the second hot melt adhesive composition comprises an ethylene vinyl acetate polymer and the release agent comprises an internal release agent having a melting point of at least about 120° C.

12. The tape of claim 1, wherein the second hot melt adhesive composition further comprises a film-forming polymer.

13. The tape of claim 1, wherein the plastic composition forms a layer that defines a first surface and an opposing second surface, the second hot melt adhesive composition encapsulates the fibrous material, the pressure sensitive adhesive layer contacts the first surface of the plastic composition layer, and the encapsulated fibrous material layer contacts the second surface of the plastic composition layer.

14. The tape of claim 13, wherein the plastic composition comprises a film-forming polymer and at least one wax.

15. The tape of claim 1, wherein the first hot melt adhesive composition encapsulates the fibrous material, the encapsulated fibrous material layer defines a first surface and a second surface, the second hot melt adhesive composition forms a layer that contacts the first surface of the encapsulated fibrous material, and the pressure sensitive adhesive layer contacts the second surface of the encapsulated fibrous material.

16. The tape of claim 15, wherein the first hot melt adhesive composition has a melt point of at least 90° C. and comprises an ethylene vinyl acetate polymer.

17. The tape of claim 16, wherein the first hot melt adhesive composition further comprises a film-forming polymer.

18. The tape of claim 15, wherein the second hot melt adhesive composition comprises an ethylene vinyl acetate polymer and the release agent comprises an internal release agent having a melting point of at least about 120° C.

19. The tape of claim 18, wherein the second hot melt adhesive composition further comprises a film-forming polymer.

20. A tape consisting of:
an encapsulated fibrous material, wherein the fibrous material is encapsulated by at least 51 g/m² of a hot melt adhesive composition that includes a release agent; and
a pressure sensitive adhesive layer that contacts the encapsulated fibrous material and that defines an outer pressure sensitive adhesive surface of the tape.

21. The tape of claim 20, wherein the hot melt adhesive composition has a melt point of at least 90° C. and comprises an ethylene vinyl acetate polymer.

22. A tear opening system for a paper board construct, comprising:
(a) a paper board substrate defining a first surface and a second surface;
(b) at least one tear tape disposed on at least one of the first surface or the second surface of the paper board substrate, wherein the tear tape includes:
a first hot melt adhesive composition or plastic composition that provides weft strength to the tape;
a second hot melt adhesive composition that includes a release agent;
an encapsulated fibrous material layer, wherein the fibrous material is encapsulated by (i) the first hot melt adhesive composition or (ii) the second hot melt adhesive composition; and
a pressure sensitive adhesive layer that defines an outer pressure sensitive adhesive surface of the tape;
wherein the first hot melt adhesive composition or plastic composition is located between the second hot melt adhesive composition and the pressure sensitive adhesive layer; and
(c) a tear-initiating element associated with the tear tape and the paper board substrate.

23. The tear opening system of claim 22, wherein the tear tape is disposed on only the first surface of the paper board substrate.

24. The tear opening system of claim 22, wherein the tear tape is disposed on only the first surface of the paper board substrate, and the system further comprises (i) a guide tape embedded within the paper board substrate between the first surface of the paper board substrate and the second surface of the paper board substrate or (ii) a guide tape disposed on the second surface of the paper board substrate.

25. The tear opening system of claim 22, wherein the paper board substrate comprises a corrugated board substrate.

26. A tear opening system for a paper board construct, comprising:
(a) a paper board substrate defining a first surface and a second surface;
(b) at least one tear tape disposed on at least one of the first surface or the second surface of the paper board substrate, wherein the tear tape consists of:
an encapsulated fibrous material, wherein the fibrous material is encapsulated by at least 51 g/m² of a hot melt adhesive composition that includes a release agent; and
a pressure sensitive adhesive layer that contacts the encapsulated fibrous material and that defines an outer pressure sensitive adhesive surface of the tape; and
(c) a tear-initiating element associated with the tear tape and the paper board substrate.

27. A container comprising:
at least one side wall panel comprising a corrugated board substrate, wherein the side wall panel defines an exterior surface and an interior surface; and
a tear opening system, wherein the tear opening system comprises:
(a) a paper board substrate defining a first surface and a second surface;
(b) at least one tear tape disposed on at least one of the first surface or the second surface of the paper board substrate, wherein the tear tape includes:
a first hot melt adhesive composition or plastic composition that provides weft strength to the tape;
a second hot melt adhesive composition that includes a release agent;
an encapsulated fibrous material layer, wherein the fibrous material is encapsulated by (i) the first hot melt adhesive composition or (ii) the second hot melt adhesive composition; and
a pressure sensitive adhesive layer that defines an outer pressure sensitive adhesive surface of the tape;
wherein the first hot melt adhesive composition or plastic composition is located between the second hot melt adhesive composition and the pressure sensitive adhesive layer, and
(c) a tear-initiating element associated with the tear tape and the paper board substrate.

28. A container comprising:
at least one side wall panel comprising a corrugated board substrate, wherein the side wall panel defines an exterior surface and an interior surface; and
a tear opening system, wherein the tear opening system comprises:
(a) a paper board substrate defining a first surface and a second surface;
(b) at least one tear tape disposed on at least one of the first surface or the second surface of the paper board substrate, wherein the tear tape consists of:
an encapsulated fibrous material, wherein the fibrous material is encapsulated by at least 51 g/mm² of a hot melt adhesive composition that includes a release agent; and
a pressure sensitive adhesive layer that contacts the encapsulated fibrous material and that defines an outer pressure sensitive adhesive surface of the tape; and
(c) a tear-initiating element associated with the tear tape and the paper board substrate.

29. A method for making a tear opening system for a paper board construct having a first surface and an opposing second surface, comprising:
applying at least one tear tape to at least the first surface of the paper board construct or the second surface of the paper board construct at a dry end section of a paper board construct manufacturing process, wherein the tear tape includes:
a first hot melt adhesive composition or plastic composition that provides weft strength to the tape;
a second hot melt adhesive composition that includes a release agent;
an encapsulated fibrous material layer, wherein the fibrous material is encapsulated by (i) the first hot melt adhesive composition or (ii) the second hot melt adhesive composition; and
a pressure sensitive adhesive layer that defines an outer pressure sensitive adhesive surface of the tape;
wherein the first hot melt adhesive composition or plastic composition is located between the second hot melt adhesive composition and the pressure sensitive adhesive layer, and
wherein the tear tape is applied such that the pressure sensitive adhesive surface of the tear tape adheres to the first surface or the second surface of the paper board substrate.

30. A method for making a tear opening system for a paper board construct having a first surface and an opposing second surface, comprising:
applying at least one tear tape to at least the first surface of the paper board construct or the second surface of the paper board construct at a dry end section of a paper board construct manufacturing process, wherein the tear tape consists of:
an encapsulated fibrous material, wherein the fibrous material is encapsulated by at least 51 g/mm² of a hot melt adhesive composition that includes a release agent; and
a pressure sensitive adhesive layer that contacts the encapsulated fibrous material and that defines an outer pressure sensitive adhesive surface of the tape, and
wherein the tear tape is applied such that the pressure sensitive adhesive surface of the tear tape adheres to the first surface or the second surface of the paper board substrate.
